(19) United States
(12) Patent Application Publication
(10) Pub. No.: US 2026/0098236 A1
(43) Pub. Date: Apr. 9, 2026

(54) DISSOLVABLE FRAGRANCE SHEET

(71) Applicant: SHEETS LAUNDRY CLUB INC., MOORESVILLE, NC (US)

(72) Inventor: MARIO TREMBLAY, ST. PETERSBURG, FL (US)

(21) Appl. No.: 18/911,225

(22) Filed: Oct. 9, 2024

(51) Int. Cl. C11D 3/50; C11D 3/00; C11D 3/22; C11D 3/37; C11D 3/42; C11D 11/00; C11D 17/04

(52) U.S. Cl. CPC C11D 3/505; C11D 3/001; C11D 3/0068; C11D 3/222; C11D 3/3753; C11D 3/42; C11D 11/00; C11D 17/044

(57) ABSTRACT

A flexible water dissolvable fragrance sheet based on a combination of PVA and a composition of perfume and/or fragrances, and ingredients consisting of thickening agents, polymers such as starch, cellulose, and other ingredients that when dried, produce a composition that remains solid and flexible when dried, and produces an fragrance sheet that remains solid and flexible when dry and then dissolves completely in water. Once the composition is mixed in proper ratios, it forms a liquid that is poured onto a drying plate and after drying results in a flexible fragrance sheet that can be used in a wide range of applications.

### FIELD OF THE INVENTION

This invention relates to a water dissolvable fragrance sheet and specifically a water dissolvable fragrance sheet containing various compositions that can add or remove odor molecules. Said composition may contain perfume or fragrance or compositions that are known to remove odors which have negative impact. Said invention may also be based on various methods to produce water dissolvable fragrance sheet for a wide range of applications. The described invention is based on a flexible polyvinyl alcohol (PVA) and comprises several other components that are designed to create a consumer product that delivers or remove odors on a combination thereof, in a wide range of applications.

### BACKGROUND OF THE INVENTION

A flexible water dissolvable fragrance sheet based on a combination of PVA and a composition of perfume or fragrances, or odor removal technologies or a combination thereof, may also contain additional ingredients consisting of thickening agents, polymers such as starch, cellulose, and other ingredients that when dried, produce a composition that remains solid and flexible when dried, and produces an fragrance sheet that remains solid and flexible when dry and then dissolves completely in water. Once the composition is mixed in proper ratios, it forms a liquid that is poured onto a drying plate and after drying results in a flexible water dissolvable fragrance sheet that can be used in a wide range of applications. In another embodiment, said composition is extruded and water dissolvable fragrance sheet can be produced in high volumes and cut to size. When wet or when in contact with water, said composition dissolves completely and releases all its active ingredients which may include perfumes, fragrances, perfume micro capsules, surfactants, chelating agents, dyes, fabric softeners, bleaching agents, enzymes,

Perfumes or fragrances or odor removing agents or odor neutralizing agents, or a combination thereof are typically found in a liquid form composition with a trigger spray nozzle or via the use of compressed gasses that releases said composition into the air or onto surfaces. One drawback with using spray products is that they are heavy and bulky making them difficult to manipulate and transport. Liquid composition to add or remove or a combination thereof are also easily spilled as the bottles or packages are stored for shipment. Additionally, said composition droplets can be sprayed outside the targeted area and when inhaled may pose a potential health hazard. Additionally, odor absorbing materials such as activated charcoal, beta cyclodextrins, odor absorbing fabrics which contains porous chambers, porous clays, waxes that can hold scents, lava rocks, felt pads, cardboard, potpourri, or a combination thereof are some of the many materials that can absorb or neutralize scents and can be combined into a final composition within the PVA film or other form of PVA substrates.

A fragrance is defined as a combination of organic compounds that produces a distinct smell or odor. A perfume is a liquid mixture used to emit a pleasant odor. Various scents are formed from fragrant essential oils derived from plants and spices or synthetic aromatic compounds. The perfume and/or fragrance manufacturing process for natural essences involves collection, extraction, blending and ageing of the product. In the collection stage, initial ingredients are obtained from various plant substances and the fatty extracts of animal products. Distillation is the most common method used to extract the perfume and/or fragrance that comes from the essential oils. Oils are then blended according to a particular formula using multiple ingredients. The sent is mixed with alcohol to stabilize the perfume and/or fragrance. Then it may take several months to years after the scent has been blended to achieve the desired scent.

There are 3 structural parts to perfumes and fragrances. The head, the middle, and the base notes to provide the first impression, body, lasting impression of the perfume and fragrances. The head note and the top note provides the initial scent that forms the first impression of the perfume. They are comprised of small light molecules that have strong fresh scent but evaporate quickly, usually 5 to 30 minutes after delivery. Common top notes include citrus (e.g., lemon and orange), light fruits (e.g., berries) and herbs (e.g., sage and lavender). The middle note mask unpleasant initial impression of the base note and provides the main body of the scent. It is comprised of more complex molecules and has a more mellow, rounded, and balancing scent than top notes. It first appears 20 to 60 minutes after delivery and usually last 2 to 4 hours. These are made of potent florals and spices such as lemongrass, rose, germanium, jasmine, nutmeg, lavender, cinnamon, and coriander. The base note ads to the middle note to boost and deepen the existing body of the scent and provide its lasting impression. It is comprised of large and heavy molecules to provide a rich and smooth nature of the scent. It is typically not perceived until 30 minutes after delivery and can last up to 24 hours. Common base notes include cedarwood, vanilla, amber, patchouli, oakmoss and musk or a combination thereof.

Perfumes or fragrances or odor removing agents or odor neutralizing agents or a combination thereof are used to give a pleasant and desirable scent and sometime to cover unpleasant scents. Scents are reported to enhance health and well-being by improving mood, reducing anxiety and stress, increasing cognitive function, and improving sleep. A link has also been identified between pleasant scents and improved pain tolerance through the activation of opioid pathways.

Perfume and/or fragrance microencapsulation is achieved by applying a strong shell around a perfume or fragrance into various types of perfume microcapsules that are designed to retain the scent over long period of time ranging from minutes to hours to days after delivery. These perfume microcapsules are an essential ingredient in laundry care products. They selectively apply the fragrance to fabric during a wash but can also by incorporated during the drying cycle of the wash. Perfume microcapsules may be added to the continuous PVA film substrate and dried into a water dissolvable fragrance sheet that can be added during the drying cycle and deliver longer lasting fragrance for days and even weeks. The perfume in such microcapsules is usually stable until the capsule is broken during wear or during exposure to moisture from the air or from sweat the is released while the garment is being used.

### SUMMARY OF THE INVENTION

In a non-limiting preferred embodiment, the invention provides a composition comprising PVA film combined with a perfume or fragrance, or a combination thereof to form a water dissolvable fragrance sheet.

Any of the non-limiting embodiments may include wherein said water dissolvable fragrance sheet is used with the additional of an odor removing agent selected from the group consisting of Ozium, Lysol, Damprid, Lemon, BioKeen, or a combination thereof, or odor neutralizing agent, such as hydrogen peroxide, or baking soda, or vinegar, or charcoal, or a combination thereof

Any of the non-limiting embodiments may include wherein said water dissolvable fragrance sheet is used during the laundry process and further added into the dryer after the washing process. Once the water dissolvable fragrance sheet has been transferred to the drying machine, said composition of the water dissolvable fragrance sheet will be coated onto the fiber of the garments and released over time with ingredients such as liquid softener, lubricants, fragrance coating ingredients or a combination thereof, to deliver a scent that can last from minutes to hours to days to even longer period of time.

Any of the non-limiting embodiments may include wherein said composition contains ingredients such as laundry boosters selected from the group consisting of Lemon Juice, NaCl, Baking Soda, Alcohol, hydrogen peroxide, Vinegar, or a combination thereof, used to deodorize the odor of the laundry process

Any of the non-limiting embodiments may include wherein said composition contains ingredients selected from the group consisting of Citronellol, Rose oil, Limonene, Essential oils, Sodium Bicarbonate or a combination thereof.

Any of the non-limiting embodiments may include wherein said water dissolvable fragrance sheet contains ingredients selected from the group consisting of Clay, Bentonite Clay, Minerals, Pine, Wheat, Corn, Silica, Silica Gel, or a combination thereof.

Any of the non-limiting embodiments may include wherein said composition contains ingredients selected from the group consisting of Essential oils, Sodium Bicarbonate, or a combination thereof.

Any of the non-limiting embodiments may include wherein said composition contains ingredients selected from the group consisting of Disodium ethylenediaminetetraacetate dihydrate, Na2EDTA, DTPA, MGDA, EDTA or a combination thereof.

Any of the non-limiting embodiments may include wherein said composition contains ingredients selected from the group consisting of Borax, Sodium Bicarbonate, Charcoal, Hypochlorite, hydrogen peroxide, vinegar, or a combination thereof.

Any of the non-limiting embodiments may include wherein said composition contains ingredients selected from the group consisting of EpsonSalt, Sodium Bicarbonate, Bentonite Clay, hydrogen peroxide, vinegar, or a combination thereof.

Any of the non-limiting embodiments may include wherein said composition contains ingredients selected from the group consisting of Essential oils, Lavender, Peppermint, Lemon, Bergamot, Ylang Ylang, Hydrosols, Resins, Carrier oils, Infused oils, Herbs, or a combination thereof.

Any of the non-limiting embodiments may include wherein said composition contains ingredients selected from the group consisting of Perfume MicroCapsules or a combination of Perfume Micro Capsules, used for the delivery of a two-step odor release composition wherein one step is right out of the washer and/or dryer during the washing process and will also release scent after said washing and drying garment process.

Any of the non-limiting embodiments may include wherein said composition contains water, starch, a surfactant, wherein the PVA, starch, surfactant and water are mixed and dried to form a water dissolvable fragrance sheet.

Any of the non-limiting embodiments may include wherein the surfactant constitutes between 5 to 50% by weight of the total mixture, and wherein the water constitutes between 1-15% by weight of the total mixture.

Any of the non-limiting embodiments may include a chelating agent selected from the group consisting of EDTA, MGDA, DTPA, zeolite, phosphonate, citric acid, citrate, or a mixture thereof.

Any of the non-limiting embodiments may include a fragrance 0 to 2% by weight.

Any of the non-limiting embodiments may include a brightening agent up to 1% by weight of the total mixture.

Any of the non-limiting embodiments may include a bleaching agent selected from the group consisting of calcium hypochlorite, sodium hypochlorite, sodium percarbonate, sodium perborate, sodium persulfate, tetrasodium pyrophosphate, or urea peroxide or a combination thereof.

Any of the non-limiting embodiments may include a fabric softener agent selected from the group consisting o fquaternary ammonium cations/salts, ceterinium bromide, quaternary ammonium chloride, polydimethylsiloxane, silicone, or a mixture thereof.

Any of the non-limiting embodiments may include a perfume, a fragrance, a perfume micro capsule or a combination thereof.

Any of the non-limiting embodiments may include a binding agent selected from the group consisting of a resin, a wax, a gum, accroides, candelilla, guar, gum Arabic, shellac, tragacanth, or a combination thereof.

Any of the non-limiting embodiments may include (a) dissolving an oil phase perfume core material in a continuous phase of a polyvinyl alcohol matrix.

Any of the non-limiting embodiments may include mixing into the PVA matrix scent absorbing ingredients selected form the group consisting of activated charcoal, beta cyclodextrins, odor absorbing fabrics which contains porous chambers, porous clays, waxes that can hold scents, lava rocks, felt pads, cardboard, and potpourri.

Any of the non-limiting embodiments may include guar, gum Arabic, shellac, tragacanth, or a combination thereof.

Any of the non-limiting embodiments may include an additional step of surface spraying the water dissolvable PVA sheet with a surface agent selected from the group consisting of a additional of an odor removing agent selected from the group consisting of Ozium, Lysol, Damprid, Lemon, BioKeen, or a combination thereof, or odor neutralizing agent, such as hydrogen peroxide, or baking soda, or vinegar, or charcoal, or a combination thereof,

Any of the non-limiting embodiments may include laundry boosters selected from the group consisting of Lemon Juice, NaCl, Baking Soda, Alcohol, hydrogen peroxide, Vinegar, or a combination thereof, used to deodorize the odor of the laundry process, Citronellol, Rose oil, Limonene, Essential oils, Sodium Bicarbonate or a combination thereof, Clay, Bentonite Clay, Minerals, Pine, Wheat, Corn, Silica, Silica Gel, or a combination thereof, Essential oils, Sodium Bicarbonate, or a combination thereof, Disodium ethylenediaminetetraacetate dihydrate, Na2EDTA, DTPA, MGDA, EDTA or a combination thereof, Borax, Sodium Bicarbonate, Charcoal, Hypochlorite, hydrogen peroxide, vinegar, or a combination thereof, Epsom Salt, Sodium Bicarbonate, Bentonite Clay, hydrogen peroxide, vinegar, or a combination thereof, Essential oils, Lavender, Peppermint, Lemon, Bergamot, Ylang Ylang, Hydrosols, Resins, Carrier oils, Infused oils, Herbs, or a combination thereof, Perfume MicroCapsules or a combination of Perfume Micro Capsules, used for the delivery of a two-step odor release composition wherein one step is right out of the washer and/or dryer during the washing process and will also release scent after said washing and drying garment process, a chelating agent selected from the group consisting of EDTA, MGDA, DTPA, zeolite, phosphonate, citric acid, citrate, or a mixture thereof, a fragrance 0 to 2% by weight, a brightening agent up to 1% by weight of the total mixture, a bleaching agent selected from the group consisting of calcium hypochlorite, sodium hypochlorite, sodium percarbonate, sodium perborate, sodium persulfate, tetrasodium pyrophosphate, or urea peroxide or a combination thereof, a fabric softener agent selected from the group consisting o fquaternary ammonium cations/salts, ceterinium bromide, quaternary ammonium chloride, polydimethylsiloxane, silicone, or a mixture thereof, a perfume, a fragrance, a perfume micro capsule or a combination thereof, a binding agent selected from the group consisting of a resin, a wax, a gum, accroides, candelilla, guar, gum Arabic, shellac, tragacanth, or a combination thereof, and scent absorbing ingredients selected from the group consisting of activated charcoal, beta cyclodextrins, odor absorbing fabrics which contains porous chambers, porous clays, waxes that can hold scents, lava rocks, felt pads, cardboard, and potpourri.

### BRIEF DESCRIPTION OF THE FIGURES

FIG. 1 is an illustration of a non-limiting embodiment of a homogenizer assembly, component feeds, and drum dryer assembly according to the invention.

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

FIG. 5 is a flow chart illustration of a non-limiting embodiment of a method of manufacturing a water dissolvable PVA sheet using a homogenizer assembly, a supply for component feeds, and a drum dryer assembly according to the invention.

FIG. 6 is a perspective illustration of a non-limiting embodiment of a drum dryer assembly showing a drum drive and a sheet winding assembly according to the invention.

FIG. 7 is a perspective illustration of a non-limiting embodiment of a drum dryer assembly showing a drum drive according to the invention.

FIG. 8 is a perspective illustration of a non-limiting embodiment of a drum dryer assembly showing a drum drive and steam inlet according to the invention.

FIG. 9 is an side view illustration of a non-limiting embodiment of a drum dryer assembly showing a drum drive, a steam inlet, and applicator roller tray according to the invention.

FIG. 10 is an end view illustration of a non-limiting embodiment of a drum dryer assembly showing a drum drive, motor, and sheet winding assembly according to the invention.

FIG. 11 is a top view illustration of a non-limiting embodiment of a drum dryer assembly showing a drum drive, motor, and sheet winding assembly according to the invention.

FIG. 12 is a cut-away view illustration of a non-limiting embodiment of a drum dryer assembly showing a drum drive, motor, dryer drum, roller tray, roller, and steam delivery conduit according to the invention.

FIG. 13 is an perspective illustration of a non-limiting embodiment of an applicator roller tray, and roller assembly according to the invention.

FIG. 14 is an perspective illustration of a non-limiting embodiment of an applicator roller tray, and roller assembly according to the invention.

FIG. 15 is an perspective illustration of a non-limiting embodiment of a tray raising/lowering assembly according to the invention.

FIG. 16 is a side view illustration of a non-limiting embodiment of a tray raising/lowering assembly according to the invention.

FIG. 17 is an perspective illustration of a non-limiting embodiment of an applicator tray, roller, and tray raising/lowering assembly according to the invention.

FIG. 18 is an perspective illustration of a non-limiting embodiment of a (sheet) feed leveling roller assembly according to the invention.

FIG. 19 is a detail illustration of a non-limiting embodiment of a leveling adjustment mechanism for the (sheet) feed leveling roller assembly according to the invention.

### DETAILED DESCRIPTION OF THE INVENTION

This invention provides a convenient and cost-effective method for delivering perfumes, or fragrances or odor removing technologies or odor neutralizing technologies or a combination thereof, using a completely new form consisting of a water dissolvable fragrance sheet. The water dissolvable fragrance sheet are formed into fibers that may be inter-connected into a fibrous matrix or simply dried into a film with different aesthetics, size and many other properties depending on the composition and purpose. The fibrous matrix of the perfumes or fragrances or odor removing agents or odor neutralizing agents or a combination thereof is made to be added to water, or some other liquid, to form an odorific compositions. Some examples include the additional of scent absorbing materials to further increases the benefit of the PVA based scent delivery system.

The composition described herein can provide for a thorough water dissolvable fragrance sheet consisting of a composition that is convenient for the consumer to water dissolvable fragrance sheete in the wash machine and act as a fabric softening composition that can be provided in a composition with a plurality of particles that can deliver softening along with the odor benefit that consumer seek for long lasting signal of freshness over time. The ingredients in said composition can be provided in a package that is separate from the washing detergent composition for the machine wash. Having the odor composition separate from the wash can be beneficial since it allows the consumer to select the amount of perfumes or fragrances or odor removing agents or odor neutralizing agents or a combination thereof independent from the wash detergent product. This can give the consumer the opportunity to customize the amount of perfumes or fragrances or odor removing agents or odor neutralizing agents or a combination thereof used and thereby the amount of scent benefit they can achieve, which is a highly valuable consumer benefit. This is especially important for the segment of consumers that are scent seekers or desire an amount of residual scent that far exceeds the typical amount of scent that is delivered with the average detergent and fabric conditioner product that is sold on the market today.

A water dissolvable fragrance sheet that is composed of ingredients that can easily be water dissolvable fragrance sheeted by consumers from a package that can be directly added into the wash or during the drying cycle that takes place after the washing machine process or can be added into the water dissolvable fragrance sheeting attachment of the washing machine or can be added directly into the drum of the wash machine, can be formulated into a dissolvable PVA sheet or similar dissolvable sheet composition. Said composition can have additional ingredients, other than the perfumes or fragrances or odor removing agents or odor neutralizing agents or a combination thereof such as quaternary ammonium compounds to contribute to the deposition of the odor ingredients and said quaternary ammonium compound increases the amount of ingredient that will deliver the perfume and/or fragrance to the garments in the wash or in the dryer cycle of the washing process.

Perfumes and fragrances have up to 30% weight/weight (wt/wt) oil concentration but are typically used in lower level in different products. For the water dissolvable fragrance sheet the concentration of the perfume and/or perfumes range from less than 1% to more than 20% depending on the application. The perfumes or fragrances or odor removing agents or odor neutralizing agents, or a combination thereof are incorporated into the PVA film and can be released as the PVA film dissolves. Said perfumes or fragrances or odor removing agents or odor neutralizing agents, or a combination thereof can be added directly into the wash in a wash machine or in a wash basin. Additionally, it preferred to be added during the drying cycle of the washing process. The fragrance sheet is added to the dryer and during the drying cycle the moisture from the garment will slowly dissolve the PVA film comprised of the perfumes or fragrances or odor removing agents or odor neutralizing agents or a combination thereof scent will be transferred from the PVA film to the garments in the dryer. The scent will then remain on the garment from minutes to hours to days depending on the composition of the water dissolvable fragrance sheet.

Some example applications include adding the fibrous matrix of water dissolvable fragrance sheet to laundry wash water and dish cleaning water. In some forms, the water dissolvable fragrance sheet may include color brighteners, bleaches, fabric softeners and anti-static materials, or any other ingredient that makes the fibrous matrix suitable for commerce, including any combination thereof.

The present invention relates to a composition for forming fibers or forming a film of synthetic and/or natural perfumes or fragrances or odor removing agents or odor neutralizing agents, or a combination thereof perfumes and fragrances. In another example form, the present invention relates to an odor fiber that is composed of scent absorbing materials. The odor fiber may include a PVA composition and may be combined with a wide range of ingredients to deliver a wide range of consumer benefits. In yet another form, the present invention relates to a water dissolvable fragrance sheet that is fabricated from odor fibers or extruded from odor filaments that results in a woven or non-woven substrate depending on the targeted application.

The present invention relates to a method of making a film containing a water-soluble composition, optionally made from polyvinyl alcohol (PVA), which is processed and may be extruded to produce filaments or fibers by converting the filaments and/or fibers and/or nonwoven webs into films. In another embodiment, the PVA is casted and formed into a film.

Casting processes for making films, particularly water-soluble films, and/or films comprising water-soluble film forming materials (e.g., polyvinyl alcohol) are known in the art. Such casting processes use a solvent and a solution of a film-forming material such as polyvinyl alcohol, which is deposited on and/or flowed over a casting surface such as a metal wheel, roller, or belt. The solvent is then removed from the solution, for example by drying. Once the solvent is removed from the solution, a film formed from the filament forming material remains on the casting surface. The casting process for making films is known to be very time intensive since the solvent needs to be removed by drying. The resulting product consists of a water dissolvable fragrance sheet and may be cut to size depending on the application.

Non-water soluble films and/or non-water soluble filament forming materials such as polypropylene, polyethylene, and thermotropic polymers (i.e., polymers that form liquid crystal melts) are, for example, water insoluble. Filaments of filament forming material have been made by spinning a web and then pressing the resulting web with heat into a film (often a porous film). However, such water-insoluble films and/or films containing water-insoluble filament forming materials are not suitable for uses and/or products that require water-soluble films.

Accordingly, films, particularly polar solvent soluble (e.g., water soluble) films, and/or polar solvent soluble filament forming materials, and/or difficulties of conventional film casting methods (specifically, solvents and film forming materials, may result in the need for a method of making a film comprising a water soluble filament forming material that avoids the fact that a film made from a casting solution containing a filament forming material is made at a low rate.

The present invention creates a film, for example a polar solvent soluble film and/or a film containing a polar solvent soluble filament forming material, by converting a nonwoven web containing filaments and/or fibers comprising a polar solvent soluble filament forming material into a film, which then is further converted to a water dissolvable fragrance sheet. By satisfying the above requirements by providing a process to do so.

In one embodiment of the present invention, the water dissolvable fragrance sheet methos is providing a nonwoven web comprising a plurality of filaments, the plurality of filaments comprising a polar solvent soluble filament forming material. Said water dissolvable fragrance sheet method is further converting the nonwoven web to a film, and a process for making a film from the nonwoven web is provided.

In another embodiment of the invention, a film made by the process according to the invention is provided. Accordingly, the present invention provides a process for making a film, a film made by such a process, and a unit volume product comprising such a film. The resulting product is a water dissolvable fragrance sheet.

### Definitions

As used herein, “filament” means an elongated microparticle having a length that greatly exceeds its diameter, i.e., a ratio of length to diameter of at least about 10.

The filaments of the present invention can be spun from the filament forming composition via suitable spinning process operations, such as melt blowing and/or spunbonding or a combination thereof.

The filaments of the present invention may be single component and/or multicomponent. For example, the filament may comprise a bicomponent filament. The bicomponent filament may be in any form such as side-by-side, core and sheath, or sea-island type.

The filaments of the present invention are 2 inches or more, and 3 inches or more, and 4 inches or more, and 6 inches or more of length.

### EMBODIMENTS

As used herein, filaments are typically considered continuous or essentially nearly continuous. Filaments are relatively longer than fibers. Non-limiting examples of filaments include meltblown and/or spunbond filaments.

As used herein, one or more fibers can be formed from the filaments of the present invention so that the filaments are cut to shorter lengths (e.g., less than 2 inches in length). Thus, in one embodiment, the present invention also comprises fibers comprising fibers made from the filaments of the present invention, such as one or more filament forming materials, and optionally one or more additives such as active agents. Including. Accordingly, references herein to the filaments of the present invention include fibers made from such filaments, unless otherwise noted. Fibers are typically considered discontinuous in nature relative to filaments that are considered to be essentially continuous.

As used herein, “filament forming composition” means a composition suitable for making the filaments of the present invention, such as by melt blowing and/or spunbonding. Filament-forming compositions comprise one or more filament-forming materials that exhibit properties that make them suitable for spinning into filaments. In one example, the filament forming material comprises a polymer. In addition to the one or more filament forming materials, the filament forming composition may include one or more additives, such as one or more active agents. Furthermore, the filament-forming composition may comprise one or more polar solvents, such as water, in which one or more, for example all filament-forming materials and/or one or more, for example all active agents, which are further dissolved or dispersed or a combination thereof.

As used herein, the filaments of the present invention are made from the filament-forming composition of the present invention has one or more additives, such as one or more active agents. The coating is such that it can be present in the filament rather than on the filament. The total concentration of filament forming material, and the total concentration of active agent present in the filament forming composition may be any suitable amount, as long as the filaments of the present invention are made therefrom.

As used herein, one or more additives, such as an active agent, may be present in the filament and one or more additional additives, such as an active agent, may be present on the surface of the filament. In other embodiments, the filaments of the present invention may include one or more additives, such as an active agent, which are present in the filament when first made, but are subject to the conditions of the intended use of the filament, further resulting in a bloom on the surface of the filaments before and/or when exposed to air or other external conditions.

As used herein, “filament-forming material” means a material such as a polymer or monomer that can produce a polymer that exhibits properties suitable for making filaments. In one example, the filament-forming material includes one or more substituted polymers, such as anionic, cationic, zwitterionic, and/or nonionic polymers. In other examples, the polymer may comprise a hydroxyl polymer, such as polyvinyl alcohol (“PVA”), and/or a polysaccharide, such as starch, and/or a starch derivative, such as ethoxylated starch, and/or acid diluted starch. In another example, the polymer may include polyethylene and/or terephthalate. In yet another embodiment, the filament forming material is a polar solvent soluble material.

As used herein, “additive” means any material that is present in the filaments of the invention and is not a filament forming material. In one example, the additive includes an active agent. In other embodiments, the additive includes a processing aid. In yet another embodiment, the additive includes a filler. In one embodiment, the additive is present in the filament, and the absence of it in the filament does not cause the filament to lose its filament structure (i.e., the absence of it causes the filament to be in its solid form.

Including any material) that will not lose. In other embodiments, the additive, e.g., the active agent, includes a non-polymeric material.

As used herein, the additive includes a plasticizer for the filament. Non-limiting examples of suitable plasticizers of the present invention include polyols, copolyols, polycarboxylic acids, polyesters, and dimethicone copolyols. Examples of useful polyols include glycerin, diglycerin, propylene glycol, ethylene glycol, butylene glycol, pentylene glycol, cyclohexanedimethanol, hexanediol, 2,2,4-trimethylpentane-1,3-diol, polyethylene glycol (200-600), sugar alcohols such as pentaerythritol, sorbitol, mannitol, lactitol and other mono-and polyhydric low molecular weight alcohols (eg C2-C8 alcohols); mono, di- and oligosaccharides such as fructose, Examples include, but are not limited to, glucose, sucrose, maltose, lactose, and higher fructose corn syrup solids, and dextrin, and ascorbic acid. In yet another example, the plasticizer includes glycerin and/or propylene glycol, and/or a glycerol derivative, such as propoxylated glycerol. In yet another embodiment, the plasticizer is selected from the group consisting of glycerin, ethylene glycol, polyethylene glycol, propylene glycol, glycidol, urea, sorbitol, xylitol, maltitol, saccharides, ethylene bisformamide, amino acids, and mixtures thereof. Is done.

As used herein, the additive includes a crosslinking agent suitable for crosslinking one or more filament-forming materials present in the filaments of the present invention. In one example, the cross-linking agent includes a cross-linking agent that can cross-link the hydroxyl polymer together, for example, via the hydroxyl portion of the hydroxyl polymer. Non-limiting examples of suitable crosslinkers include imidazolidinone, polycarboxylic acids, and mixtures thereof. In one example, the cross-linking agent comprises a urea glyoxal adduct cross-linking agent, for example, a dihydroxy imidazolidinone such as dihydroxyethylene urea (“DHEU”). Crosslinking agents may be present in the filament forming composition of the present invention and/or in the filaments to control the solubility and/or dissolution of the filaments in a solvent such as a polar solvent.

As used herein, the additive comprises a rheology modifier such as a shear force modifier and/or an extension modifier. Non-limiting examples of rheology modifiers include, but are not limited to, polyacrylamides, polyurethanes, and polyacrylates that can be used in the filaments of the present invention. Non-limiting examples of rheology modifiers are commercially available from Dow Chemical Company (Midland, MI).

As used herein, the additive may be used when the filament is exposed to the intended application conditions and/or when the active agent is released from the filament and/or when the morphology of the filament changes. To provide a visual signal, it includes one or more colors and/or dyes incorporated into the filaments of the present invention.

As used herein, the additive includes one or more release agents and/or lubricants. Non-limiting examples of suitable release agents and/or lubricants include fatty acids, fatty acid salts, fatty alcohols, aliphatic esters, sulfonated fatty acid esters, aliphatic amine acetates, fatty acid amides, silicones, aminosilicones, fluoropolymers, and mixtures thereof. In one embodiment, the release agent and/or lubricant is applied to the filament, in other words, after the filament is formed. In one example, one or more release agents/lubricants are applied to the filaments prior to collecting the filaments on the collection device to form a nonwoven. In other embodiments, one or more release agents/lubricants are applied to a nonwoven formed from the filaments of the present invention prior to contacting one or more nonwoven webs, such as a stack of nonwoven webs. In yet another embodiment, to facilitate removal of the filaments and/or nonwoven webs of the present invention and/or the layers of the filament/nonwoven webs of the present invention are adhered to each other, and further carelessly adhered. To avoid, the filaments and/or nonwovens comprising the filaments of the present invention may have one or more release agents/before the filaments and/or nonwovens contact the surface (such as the surface of an apparatus used in a processing system). Lubricant is applied. In one example, the release agent/lubricant includes particulates.

As used herein, the additive includes one or more antiblocking agents and/or tack removers. Non-limiting examples of suitable antiblocking and/or detackifying agents include starch, starch derivatives, crosslinked polyvinylpyrrolidone, crosslinked cellulose, microcrystalline cellulose, silica, metal oxides, calcium carbonate, talc, mica, or a combination thereof.

As used herein, “purpose application conditions” refers to the temperature, physical, chemical, and exposure to which the filaments of the invention are exposed when used for one or more of their design purposes. Means mechanical conditions. For example, if the filament and/or the nonwoven web comprising the filament is designed to be used in a washing machine for laundry care purposes, the condition of the intended use is any wash water during the laundry wash operation. Will include these temperatures, chemical, physical, and/or mechanical conditions present in the washing machine. In other examples, if the filament and/or the nonwoven web comprising the filament is designed to be used by humans as a shampoo for hair care purposes, the conditions for the intended use are during human hair shampooing. These temperatures, chemical, physical and/or mechanical conditions that exist will be included. Similarly, if the filament and/or the nonwoven web comprising the filament is designed to be used in a dishwashing operation by hand or by a dishwasher, the intended use condition is that the dishwashing water during the dishwashing operation is and/or these temperatures, chemical, physical, and/or mechanical conditions present in the dishwasher.

As used herein, an “active agent” is used in the environment outside of a filament and/or a nonwoven web comprising the filament of the invention, e.g., the purpose of the filament and/or nonwoven web comprising the filament. By an additive that produces the intended effect when exposed to the conditions of use. In one example, the active agent is a surface, such as a hard surface (i.e., kitchen counter, bathtub, toilet, toilet bowl, sink, floor, wall, tooth, car, window, mirror, dish) and/or a soft surface (i.e., Fabrics, hair, skin, carpets, crops, plants). In other embodiments, the activator is a chemical reaction (i.e., foaming, foaming, coloring, increasing temperature, cooling, foaming, disinfection and/or purification, and/or chlorination, e.g., water purification, and/or water used in the disinfection and/or chlorination of water). In yet another embodiment, the active agent includes an additive that treats the environment (i.e., deodorizes, purifies, or aromas the air). In one example, the active agent is formed in situ, such as during the formation of a filament containing the active agent, e.g., the filament comprises a water soluble polymer (e.g., starch) and a surfactant (e.g., an anionic surfactant). However, they can create polymeric complexes, i.e., coacervates, that function as active agents used to treat the surface of the fabric.

As used herein, “Treat”, with respect to surface treatment means that the active agent provides a benefit to the surface or environment. Treatment includes controlling and/or immediately improving the appearance of the surface or environment, cleanliness, odor, purity, and/or feel. In one example, treatment relating to the treatment of the surface of keratinous tissue (e.g., skin and/or hair) means modulation of the superficial appearance and/or feel of keratinous tissue and/or instantaneous improvement. For example, “adjusting the condition of the skin, hair, or nails (keratinous tissue)” may increase the thickness of the skin, hair, or nails (e.g., skin condition) to reduce skin, hair, or nail atrophy. Construction of the epidermis and/or dermis and/or sub-dermal (e.g., subcutaneous fat or muscle) layer and, where applicable, construction of the stratum corneum of the nail and hair shaft), at the dermis-epidermal boundary Increased convolution (also known as interpapillary ridge), melanin or non-melanin changes in the skin, hair, or nail color under the eyes, spots (e.g., uneven red color due to rosacea, etc.).

As used herein, treatment means removing odors from fabric articles (cloth, towels, linens, etc.) and/or hard surfaces (including counters and/sink, toilets, etc.).

As used herein, “personal care active agent” means an active agent that can be applied to mammalian keratinous tissue that does not have undue undesirable efficacy.

As used herein, “keratinous tissue” means a keratin-containing layer that is placed as the outermost protective covering of a mammal, including skin, hair, scalp, and nails.

As used herein with respect to mammalian keratinous tissue, “beauty benefits” or “effects” include washing, sebum prevention, reducing the greasy and/or shiny appearance of skin and hair, dryness, Reduces itching and/or flakiness, skin pore size, exfoliation, reduction of desquamation, keratinous tissue appearance, conditioning, smoothing, skin deodorization and/or antiperspirant effect.

“Cosmetics active agent” as used herein refers to an active agent capable of delivering one or more cosmetic effects.

As used herein, “skin care active” means an active that provides an effect or improvement to the skin when applied to the skin. Skin care actives are useful not only for skin, but also when applied to hair, scalp, nails, and other mammalian keratinous tissues.

As used herein, “hair care active agent” means an active agent that, when applied to mammalian hair, provides an effect and/or improvement on the hair. Non-limiting examples of effects and/or improvements on hair include flexibility, static control, hair repair, dandruff removal, dandruff resistance, hair color, shape retention, hair retention, and hair growth.

As used herein, “fabric care active agent” means an active agent that, when applied to a fabric, provides a benefit and/or improvement to the fabric. Non-limiting examples of fabric benefits and/or improvements include addition of perfume and/or fragrance, removal of undesirable scents or smell, reduction of undesirable scent or smell, deodorant, wrinkle removal, color recovery, static control, wrinkle resistance, permanent press, wear reduction, Abrasion resistance, pill removal, pill resistance, dirt removal, dirt resistance (including dirt release), shape retention, shrinkage reduction, flexibility, fragrance, antibacterial, and antiviral.

As used herein, “scent activator” refers to garments or fabrics when applied to fabrics made of materials such as cotton, polyester, poly-cotton, silk, synthetic polymers (e.g., lycra and related synthetic fibers, running gear etc.). This also applies to bedding sheets, blankets, wraps, towels. Means that it provides benefits and/or improvements to odor integrity of the sheet. Non-limiting examples of benefits and/or improvements to air surrounding.

“Hard surface-active agent” as used herein refers to a floor, counter, sink, window, mirror when applied to a floor, counter, sink, window, mirror, shower, bathroom, and/or toilet. Active agent that benefits the shower, bathroom, and/or toilet. Non-limiting examples of benefits and/or improvements to floors, counters, sinks, windows, mirrors, showers, bathrooms, and/or toilets include mildew, un-pleasant smell, or other undesirable scent or smell from the hard surfaces.

An “ingestible active agent” as used herein is defined by an animal, such as a mammal (such as a human), in the animal, mouth, nose, eyes, ears, pores, rectum, vagina, or other opening or by a wound (such as delivery of an active agent by a wound dressing) is meant an active agent suitable for ingestion and/or consumption. Non-limiting examples of ingestible active agents include feminine hygiene active agents, infant care active agents, oral care active agents, pharmaceutical active agents, vitamins, nutritional active agents (e.g., delivered in new food forms), pet care actives, and mixtures thereof.

“Liquid processing active agent” as used herein means an active agent that provides benefits and/or improvements to a liquid when applied to a liquid such as water and/or alcohol. For example, chlorine and/or other swimming pool chemicals are non-limiting examples of suitable liquid treatment activators. In other examples, water purification and/or water disinfecting activators, such as commercial water filtration and/or water treatment techniques, are suitable for the filaments of the present invention. In addition, oil dispersants and/or oil scavengers are non-limiting examples of other suitable liquid treatment actives.

As used herein, “industrial active agent” means an active agent that provides benefits within the article of manufacture. For example, glues and/or adhesives that provide a bond between two objects, pesticides, food and/or septic articles incorporated in insulators (e.g., housing insulators) Oxygen scavenging active agents incorporated into packages, insect repellents incorporated into articles used by humans to repel insects, and moisture scavengers incorporated into desiccants are present in the filaments of the present invention. Non-limiting examples of industrial activators obtained.

“Weight ratio”, as used herein, refers to the weight of the additive, e.g., the filament-forming material on a dry weight basis in the filament to the active agent (g or %) in the filament on a dry weight basis. It means weight (g or %). The final concentration is expressed as weight percent (wt. %).

As used herein, “hydroxyl polymer” includes any hydroxyl-containing polymer that can be incorporated into the filaments of the present invention, e.g., as a filament-forming material. In one example, the hydroxyl polymer of the present invention comprises greater than 10 wt % and/or greater than 20 wt. % and/or greater than 25 wt. % hydroxyl moieties.

“Biodegradable” as used herein with respect to a material, such as a material, for example as a whole filament and/or as a polymer within a filament (e.g., filament-forming material), for example, at least of the initial filament and/or polymer. 5%, and/or 7%, and/or at least 10% according to OECD (1992) “Guideline for the Testing of Chemicals 301B; Ready Biodegradability-CO 2 Evolution (Modified T) When measured, filaments and/or polymers can be converted to carbon dioxide in public solid waste composting facilities so that they are converted to carbon dioxide after 30 days. They can undergo a beauty/or biodegradable, and/or means that go through it.

“Non-biodegradable” as used herein with reference to materials such as whole filaments and/or polymers within filaments (e.g. filament-forming material) filaments, e.g., at least 5% of the initial filaments and/or polymers. As measured after 30 days as measured according to OECD (1992) “Guideline for the Testing of Chemicals 301B; Ready Biodegradability—CO 2 Evolution (Modified Storm Test) Test” incorporated herein. In particular, it means that the filament and/or polymer cannot undergo physical, chemical, thermal and/or biodegradation.

“Non-thermoplastic” as used herein with respect to materials such as whole filaments and/or polymers within filaments (eg, filament-forming materials), filaments and/or polymers do not exhibit a melting point and/or softening point. This means that when there is no plasticizer such as water, glycerin, sorbitol, urea, it can flow under pressure.

As used herein, “non-thermoplastic biodegradable filament” means a filament that exhibits biodegradable and non-thermoplastic properties as defined above.

As used herein, “non-thermoplastic, non-biodegradable filament” means a filament that exhibits non-biodegradable and non-thermoplastic properties as defined above.

“Thermoplastic” as used herein with respect to materials such as the entire filament and/or polymer within the filament (e.g., filament forming material), the filament and/or polymer has a melting point and/or softening point at a particular temperature. Which allows it to flow under pressure in the absence of a plasticizer.

As used herein, “thermoplastic biodegradable filament” means a filament that exhibits biodegradable and thermoplastic properties as defined above.

As used herein, “thermoplastic, non-biodegradable filament” means a filament that exhibits non-biodegradable and non-thermoplastic properties as defined above.

As used herein, “non-cellulose containing” is less than 5% by weight and/or less than 3% by weight and/or less than 1% by weight and/or less than 0.1% by weight. In addition, it means that weight percent cellulose polymer, cellulose derivative polymer and/or cellulose copolymer is present in the filament. In one example, “non-cellulose-containing” is less than 5% by weight and/or less than 3% by weight and/or less than 1% by weight and/or less than 0.1% by weight and/or 0% by weight.

As used herein, “polar solvent soluble material” means a material that is miscible in a polar solvent. In one example, the polar solvent soluble material is miscible in alcohol and/or water. In other words, the polar solvent soluble material forms a homogeneous solution that is stable at ambient conditions with a polar solvent, such as alcohol and/or water (no phase separation for more than 5 minutes after forming a homogeneous solution).

As used herein, “alcohol soluble material” means a material that is miscible within the alcohol. In other words, it is a material that can form a homogeneous solution that is stable with alcohol at ambient conditions (it does not phase separate for more than 5 minutes after forming a homogeneous solution).

As used herein, “water soluble material” means a material that is miscible in water. In other words, it is a material that can form a homogeneous solution that is stable with water (does not separate for more than 5 minutes after forming a homogeneous solution) at ambient conditions.

As used herein, “nonpolar solvent soluble material” means a material that is miscible in a nonpolar solvent. In other words, a non-polar solvent soluble material is a material that can form a stable solution with a non-polar solvent (which does not phase separate for more than 5 minutes after forming a homogeneous solution).

As used herein, “ambient conditions” means about 23° C.±2.2° C. (about 73° F.±4° F.) and 50%±10% relative humidity.

As used herein, “weight average molecular weight” means gel penetration according to the procedure found in “Colloids and Surfaces A. Physico Chemical & Engineering Aspects” (Vol. 162, 2000, pg. 107-121). It means the weight average molecular weight determined using chromatography.

As used herein with respect to a filament, “length” means the length along the longest axis from one end to the other end. If the filament is kinked, curved, or bent within it, the length is the length along the entire path of the filament.

As used herein with respect to filaments, “diameter” is measured according to the diameter test method described herein. In one embodiment, the filaments of the invention are less than 100 μm and/or less than 75 μm and/or less than 50 μm and/or less than 25 μm and/or less than 20 μm and/or less than 15 μm and/or exhibit a diameter of less than 10 μm and/or less than 6 μm and/or greater than 1 μm and/or greater than 3 μm.

As used herein, in yet another examples, incentive conditions may be present in the environment (e.g., water, etc.) when the filaments and/or nonwoven webs, and/or films of the present invention are added to water. In other words, nothing changes in water except for the fact that the filaments and/or nonwoven webs and/or films of the present invention have been added to water.

As used herein with respect to filament morphological changes, “morphological change” means that the filament experiences a change in its physical structure. Non-limiting examples of morphological changes for the filaments of the present invention include melting, melting, expanding, shrinking, shattering, rupturing, extending, shortening, and combinations thereof. The filaments of the present invention may lose their physical structure completely or substantially when exposed to the intended application conditions, their morphologies may change, or the filaments It can retain or substantially retain the physical structure.

As used herein, “by weight on a dry filament basis” means that the filament is in a room conditioned at a temperature of 23° C.±2.2° C. (approximately 73° F.±4° F.) and a relative humidity of 50%±10% for 2 hours, It means the filament weight measured immediately after being adjusted. In one example, “by weight of dry filament base” refers to the weight of the filament based on the weight of the filament in moisture, eg, free water, as measured, for example, according to the moisture content testing method described herein. Less than 20% and/or less than 15% and/or less than 10% and/or less than 7% and/or less than 5% and/or less than 3% and/or less than 1%.

As used herein with respect to the total concentration of one or more active agents present in the filament, “total concentration” means the total weight or weight percent of all subject material (e.g., active agents). In other words, the filament comprises 50 wt % of perfume or fragrance on a dry filament basis. Optionally an additional 35 wt. % of anionic surfactant on a dry filament basis, 15 wt % nonionic surfactant on a dry filament basis, 10 wt. % chelating agent, and 5 wt. % perfume. So that the total concentration of active perfume or fragrance agent present in the filament is greater than 50% by weight on a dry filament basis.

As used herein, a “web” is a collection of formed fibers and/or filaments (e.g., fibrous structures) and/or fibers and/or filaments of any attribute or origin associated with each other. It means a formed sheet (for example, a continuous filament).

As used herein, the web is a sheet formed by a spinning process rather than a casting gloss.

As used herein, a “nonwoven web” as defined for purposes of the present invention, and generally in the European Disposables and Nonwovens Association (EDANA), is a sheet of fibers and/or filaments (e.g., any means) or the like, continuous filaments of any quality or origin, etc., which can be joined together by any means except weaving or braiding. The felt obtained by wet milling is not a nonwoven web.

As used herein, a nonwoven web according to the present invention refers to regularly arranged filaments within a structure to perform a function.

As used herein, the nonwoven web of the present invention is in an arrangement that includes two or more and/or three or more filaments that are entangled within or otherwise associated with each other to form a nonwoven web. is there.

As used herein the nonwoven web of the present invention may include one or more solid additives, such as particulates and/or fibers, in addition to the filaments of the present invention.

As used herein, “microparticle” means a particulate material and/or powder.

As used herein, the articles “a” and “an” as used herein, such as “an anionic surfactant” or “a fiber” are claimed. Alternatively, it is understood to mean one or more substances described.

As used herein, the percentages and ratios are calculated by weight unless otherwise indicated. All percentages and ratios are calculated based on the total composition unless otherwise indicated.

As used herein, unless otherwise stated, all concentrations of a component or composition relate to the activity level of that component or composition and exclude impurities that may be present in commercial sources, such as residual solvents or by-products. Is done.

As used herein, the filament of the present invention comprises one or more filament forming materials. In addition to the filament forming material, the filament includes one or more active agents that are releasable from the filament, for example when exposed to the conditions of the intended application, and one or more filament forming materials present in the filament. The total concentration is less than 80% by weight on a dry filament basis, and the total concentration of one or more active agents present in the filament is provided above 20% by weight on a dry filament basis.

As used herein, the water dissolvable fragrance sheet is produced from one or more filament-forming materials with or without one or more additives (deactivator additives) and then coated with one or more active agents. The filament in contact with is not within the scope of the present invention. However, one or more filament forming materials and filaments formed from one or more active agents, such as one or more filament forming materials with or without one or more inactive agents, and one filament formed from a mixture with the above active materials (i.e., the filament forming composition of the present invention) that are subsequently coated with one or more active agents are within the scope of the present invention.

As used herein the filaments of the present invention include one or more filament forming materials and one or more active agents, wherein the total concentration of filament forming material present in the filaments is about 5 on a dry filament basis. The total concentration of active agent present in the total filament composition is from 50% to less than 50% by weight, or greater than 50% by weight and up to about 95% by weight on a dry filament basis.

As used herein, the filaments of the present invention are about 100% by weight and/or greater than 95%, and/or greater than 90% and/or greater than 85% by weight and/or One or more filament-forming materials comprising more than 75% and/or more than 50% by weight. For example, the filament forming material may comprise polyvinyl alcohol and/or starch or starch derivatives.

As used herein the filaments of the present invention include one or more filament forming materials and one or more active agents, wherein the total concentration of filament forming material present in the filaments is about dry filament basis. The total concentration of active agent present in the filaments, from 5% to less than 80% by weight, is greater than 20% by weight and up to about 95% by weight on a dry filament basis.

As used herein, the filaments of the present invention are at least 10% and/or at least 15% and/or at least 20% and/or less than 80% and/or 75% by weight on a dry filament basis. Less than and/or less than 65% and/or less than 60% and/or less than 55% and/or less than 50% and/or less than 45% and/or less than 40%.

As used herein, the filaments of the present invention are more than 20 wt. % and/or at least 35 wt. %, and/or at least 40 wt. %, and/or at least 50 wt. %, and/or at least 60 wt. %, and/or at least 65 wt. %, and/or less than 95 wt. %.

As used herein, the filaments of the present invention are less than 90 wt %, or less than 85 wt. %, and/or less than 80 wt. %, less than 75 wt. %. The filaments of the present invention comprise greater than 80% by weight active agent on a dry filament basis.

As used herein, the one or more filament forming materials and the active agent have a weight ratio of the total concentration of the filament forming material to the active agent of 4.0 or less, and/or 3.5 or less, and/or 3 0.0 or less and/or 2.5 or less and/or 2.0 or less and/or 1.85 or less and/or less than 1.7 and/or less than 1.6. And/or less than 1.5 and/or less than 1.3 and/or less than 1.2 and/or less than 1 and/or less than 0.7 and/or less than 0.5 And/or less than 0.4 and/or less than 0.3 and/or more than 0.1 and/or more than 0.15 and/or more than 0.2 filaments exists within.

As used herein, the filaments of the present invention comprise from about 10% and/or from about 15% to less than 80% filament-forming material (e.g., polyvinyl alcohol polymer and/or starch polymer) on a dry filament basis. And up to about 90% and/or up to about 85% by weight of additives (e.g., active agents) on a dry filament basis. The filament further comprises a plasticizer, such as glycerin, and/or a pH adjuster, such as citric acid.

As used herein, the filaments of the present invention comprise from about 10% and/or from about 15% to less than 80% filament-forming material (eg, polyvinyl alcohol polymer and/or starch polymer) on a dry filament basis. And, based on dry filaments, greater than 20 wt. %, Up to about 90 wt. % And/or up to about 85 wt. % active agent, wherein the weight ratio of filament forming material to active agent is 40 wt. % or less. The filament further comprises a plasticizer, such as glycerin, and/or a pH adjuster, such as citric acid.

As used herein, the filaments of the present invention comprise about 5% to less than 50% by weight filament forming material (e.g., polyvinyl alcohol polymer and/or starch polymer) on a dry filament basis and 50% on a dry filament basis. And up to about 95% by weight of additives, such as active agents (e.g., perfumes or fragrances or odor removing agents or odor reducing agents or a combination thereof). The filament further comprises a plasticizer, such as glycerin, and/or a pH adjuster, such as citric acid.

As used herein, the filaments of the present invention have 0% to less than 20% and/or 0% to 15%, as measured according to the moisture content test method described herein. Less than 15% and/or more than 0% and less than 15% and/or more than 0% and less than 12% and/or more than 2% and less than 10wt. %.

As used herein, the filaments of the present invention have from about 5 wt % to about 10 wt %, and/or from about 7 wt % to about 10 wt %, as measured according to the moisture content test method described herein.

As used herein, the filament comprises one or more filament forming materials and enzymes, bleaches, builders, chelates that are releasable and/or released when the filament is exposed to the intended application conditions. And one or more active agents selected from the group consisting of these agents, and mixtures thereof.

As used herein, the filaments are less than 95% and/or less than 90%, and/or less than 80%, and/or less than 50%, and/or less than 35%, and/or less, on a dry filament basis, and/or up to about 5% by weight and/or up to about 10% by weight and/or up to about 20% by weight of the total concentration of filament-forming material and more than 5% and/or 10% by weight on a dry filament basis.

As used herein, the filaments are more than 20% and/or more than 35% and/or more than 50% and/or more than 65% and/or up to about 95% by weight of a total concentration of active agents selected from the group consisting of enzymes, bleaches, builders, chelating agents, and mixtures thereof.

As used herein, the filaments of the present invention may contain active agents that may raise health and/or safety concerns when they are airborne. For example, the filament may be used to prevent enzymes in the filament from floating in the air.

As used herein, the filaments of the present invention may be meltblown filaments.

As used herein, the filaments of the present invention may be spunbond filaments.

As used herein the filament may be a hollow filament before and/or after release of one or more of its active agents.

As used herein, the filaments of the present invention may be hydrophilic or hydrophobic. The filaments may be surface treated and/or treated internally to alter the filament's inherent hydrophilic or hydrophobic properties.

As used herein, the filament is less than 100 μm, and/or less than 75 μm, and/or less than 50 μm, and/or less than 25 μm, and/or less than 10 μm, as measured according to the diameter test method described herein.

As used herein, the diameter of the filament may be less than 5 μm and/or less than 1 μm in diameter.

As used herein, the filaments of the present invention exhibit a diameter of greater than 1 μm as measured according to the diameter test method described herein. The diameter of the filaments of the present invention may be used to control the release rate of one or more active agents present in the filament and/or the loss of and/or changing the physical structure of the filament.

As used herein, the filament may contain two or more different active agents.

As used herein, the filament includes two or more different active agents, the two or more different active agents being compatible with each other.

As used herein he filament includes two or more different active agents, and the two or more different active agents are incompatible with each other.

As used herein, the filament may include an active agent within the filament and an active agent on the outer surface of the filament, such as a coating on the filament. The active agent on the outer surface of the filament may be the same as or different from the active agent present in the filament. If different, the active agents may be compatible with each other or incompatible.

As used herein, the filaments of the present invention do not contain preservatives, which for the purposes of the present invention are based on dry filaments, less than 2%, and/or less than 1%, and/or 0. Means less than 5% and/or less than 0.25% and/or 0% preservative.

As used herein, the one or more active agents may be uniformly dispersed throughout the filament or may be substantially uniformly dispersed.

As used herein, one or more active agents may be dispersed as separate regions within the filament.

As used herein, the at least one active agent is uniformly or substantially uniformly dispersed throughout the filament, and at least the other active agent is dispersed as one or more separate regions within the filament.

As used herein, at least one active agent is dispersed as one or more discrete regions within the filament, and the at least one other active agent is one or more from the first separate region within the filament. The filament may be used as a separate article.

As used herein, the filament is a carrier substrate (eg, wipe, paper towel, toilet paper, decorative paper, sanitary napkin, tampon, diaper, adult incontinence article, wash cloth, dryer sheet, laundry sheet, laundry bar, dry cleaning sheet, mesh product, filter paper, fabric, garment, underwear, etc.) and/or deposited thereon.

As used herein, the plurality of filaments of the present invention are collected into and compressed into a film and thus released from the film when one or more filament forming materials and, for example, the film is exposed to the intended application conditions. It can be a film comprising one or more active agents that are possible.

As used herein, the films of the present invention have a per sample less than than 100 seconds, and/or less than 80 seconds, and/or as measured according to the dissolution test methods described herein. It exhibits an average degradation time of less than 55 seconds and/or less than 50 seconds and/or less than 40 seconds and/or less than 30 seconds and/or 20 seconds/g (s/g).

As used herein, the films of the present invention have a per sample less than 1000 seconds, and/or less than 900 seconds, and/or less than 800 seconds, and/or as measured according to the dissolution test methods described herein. Alternatively, it exhibits an average degradation time of less than 700 seconds and/or less than 600 seconds and/or less than 500 seconds/g (s/g).

As used herein, the film of the present invention has a thickness greater than 0.01 mm and/or greater than 0.05 mm and/or 0.1 mm as measured by the thickness test method described herein.

As used herein, the film of the present invention may be greater than and/or up to about 20 mm and/or up to about 10mmand/oruptoabout5mmand/oruptoabout2mmand/orupto0.5mmand/orabout0. Thefilm thickness may be up to 3 mm.

As used herein, the filament-forming material is any suitable material, such as a polymer or monomer that can produce a polymer that exhibits properties suitable for making filaments, such as by a spinning process.

As used herein, the filament forming material may comprise a polar solvent soluble material, such as an alcohol soluble material and/or a water soluble material.

As used herein, the filament forming material may include a non-polar solvent soluble material.

As used herein, the filament forming material may include a polar solvent soluble material and may not include a non-polar solvent soluble material (less than 5% by weight and/or 3% by weight on a dry filament basis). Less than and/or less than 1% by weight and/or 0% by weight).

As used herein, the filament forming material may be a film forming material. In yet other embodiments, the filament-forming material may be synthetic or naturally derived, which may be chemically, enzymatically and/or physically modified.

As used herein, the filament forming material is a polymer derived from acrylic monomers such as ethylenically unsaturated carboxylic acid monomers and ethylenically unsaturated monomers, polyvinyl alcohol, polyacrylates, polymethacrylates, Copolymers of acrylic acid and methyl acrylate, polyvinyl pyrrolidone, polyalkylene oxide, starch and starch derivatives, pullulan, gelatin, hydroxylpropyl methylcellulose, methylcellulose, and polymers selected from the group consisting of carboxymethylcellulose may be included.

As used herein, the filament forming material is polyvinyl alcohol, polyvinyl alcohol derivative, starch, starch derivative, cellulose derivative, hemicellulose, hemicellulose derivative, protein, sodium alginate, hydroxypropylmethylcellulose, chitosan, chitosan derivative, polyethylene glycol, tetra It may include a polymer selected from the group consisting of methylene ether glycol, polyvinyl pyrrolidone, hydroxymethyl cellulose, hydroxyethyl cellulose, and mixtures thereof.

As used herein, the filament-forming material comprises pullulan, hydroxypropylmethylcellulose, hydroxyethylcellulose, hydroxypropylcellulose, polyvinylpyrrolidone, carboxymethylcellulose, sodium alginate, xanthan gum, tragacanth gum, guar gum, acacia gum, gum arabic, polyacrylic acid, methyl Methacrylate copolymer, carboxyvinyl polymer, dextrin, pectin, chitin, levan, erucinane, collagen, gelatin, zein, gluten, soy protein, casein, polyvinyl alcohol, starch, starch derivative, hemicellulose, hemicellulose derivative, protein, chitosan, chitosan derivative, Polyethylene glycol, tetramethylene ether glycol, Mud carboxymethylcellulose, and comprises a polymer selected from the group consisting of mixtures.

As used herein, the polar solvent-soluble materials include polar solvent-soluble polymers. The polar solvent soluble polymer may be synthetic or naturally derived and may be chemically and/or physically modified.

As used herein, the polar solvent soluble polymer is at least about 10,000 g/mol, and/or at least about 20,000 g/mol, and/or at least 40,000 g/mol, and/or at least 80,000 g/mol, And/or at least about 100,000 g/mol, and/or at least 1,000,000 g/mol, and/or at least 3,000,000 g/mol, and/or at least 10,000,000 g/mol, and/or It exhibits a weight average molecular weight of at least 20,000,000 g/mol and/or up to about 40,000,000 g/mol and/or up to about 30,000,000 g/mol.

As used herein, the polar solvent soluble polymer is selected from the group consisting of alcohol soluble polymers, water soluble polymers, and mixtures thereof. Non-limiting examples of water soluble polymers include water soluble hydroxyl polymers, water soluble thermoplastic polymers, water soluble degradable polymers, water soluble non biodegradable polymers, and mixtures thereof.

As used herein, the water soluble polymer comprises polyvinyl alcohol. In other examples, the water soluble polymer comprises starch. In yet another embodiment, the water soluble polymer comprises polyvinyl alcohol and starch.

As used herein, the solvent consists of a water-soluble hydroxyl polymers according to the present invention include polyols such as polyvinyl alcohol, polyvinyl alcohol derivatives, polyvinyl alcohol copolymers, starch, starch derivatives, starch copolymers, chitosan, chitosan derivatives, Chitosan copolymers, cellulose, cellulose derivatives, such as cellulose ether and ester derivatives, cellulose copolymers, hemicellulose, hemicellulose derivatives, hemicellulose copolymers, gums, arabinans, galactants, proteins and various other polysaccharides, and mixtures thereof.

As used herein, the water soluble hydroxyl polymer of the present invention comprises a polysaccharide.

As used herein, “polysaccharide” means natural polysaccharides and polysaccharide derivatives or modified polysaccharides. Suitable water soluble polysaccharides include, but are not limited to starch, starch derivatives, chitosan, chitosan derivatives, cellulose derivatives, hemicelulose, hemicellulose derivatives, gums, arabinans, galactans, and mixtures thereof. The water-soluble polysaccharide is from about 10,000 g/mole to about 40,000,000 g/mole and/or more than 100,000 g/mole and/or more than 1,000,000 g/mole. Alternatively, it may exhibit a weight average molecular weight of greater than 3,000,000 g/mol and/or greater than about 3,000,000 g/mol and up to about 40,000,000 g/mol.

As used herein, the water-soluble polysaccharide may comprise non-cellulose and/or non-cellulose derivatives and/or non-cellulose copolymer water-soluble polysaccharides. Such non-cellulose soluble polysaccharides may be selected from the group consisting of starch, starch derivatives, chitosan, chitosan derivatives, hemicellulose derivatives, hemicellulose derivatives, gums, arabinans, galactans, and mixtures thereof.

As used herein, the water soluble hydroxyl polymer of the present invention comprises a non-thermoplastic polymer.

As used herein, the water-soluble hydroxyl polymer can be from about 10,000 g/mol to about 40,000,000 g/mol, and/or more than 100,000 g/mol, and/or more than 1,000,000 g/mol, and/or more than 3,000,000 g/mol and up to about 40,000,000 g/mol. Higher and lower molecular weight water-soluble hydroxyl polymers may be used in conjunction with hydroxyl polymers having a weight average molecular weight within a particular desired range.

As used herein, the water soluble hydroxyl polymers may be selected from natural starch and include chemical and/or enzymatic modifications.

As used herein, the water soluble hydroxyl polymer may be combined with native starch which can further be acid-thinned, hydroxyethylated, hydroxypropylated, and/or oxidized.

As used herein, the water soluble hydroxyl polymer may comprise dent corn starch.

As used herein, the naturally occurring starch is generally consisting of a mixture of linear amylose and branched amylopectin polymers of D glucose units. Amylose is essentially a linear polymer of D-glucose linked by (1,4)-α-D bonds. Aminopectin is a highly branched polymer of (1,4)-α-D bonds and (1,6)-α-D-glucose units at branch points. Naturally occurring starch is typically a relatively high concentration of amylopectin, such as corn starch (64-80% amylopectin), waxy maize (93-100% amylopectin), rice (83-84% amylopectin), potato (About 78% amylopectin) and wheat (73-83% amylopectin). Although all starches are potentially useful herein, the present invention is most commonly practiced with high amylopectin natural starch derived from agricultural sources, which is an abundant source and can be easily supplemented and offers the advantage of being inexpensive.

As used herein, the “starch” includes any naturally occurring unmodified starch, modified starch, synthetic starch, and mixtures thereof, and mixtures of amylose or amylopectin fractions, It may be modified by chemical, chemical, or biological processes, or combinations thereof.

As used herein, the unmodified or modified starch may depend on the desired end product.

As used herein, the starch or starch mixture useful in the present invention is from about 20% to about 100%, more typically from about 40% to about 90%, even more typically. Having an amylopectin content from about 60 wt % to about 85 wt % starch or mixtures thereof.

As used herein, suitable starches of natural origin include: corn starch, potato starch, sweet potato starch, wheat starch, sago palm starch, tapioca starch, rice starch, soybean starch, arrow root starch, amino starch, bracken starch, lotus starch, Non-limiting examples include waxy corn starch and high amylose corn starch. Naturally occurring starches, particularly corn starch and wheat starch, are preferred starch polymers due to their economics and availability.

As used herein, the polyvinyl alcohol herein can be grafted with other monomers to improve its properties. A wide range of monomers have been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, maleic acid, itaconic acid, vinyl sulfonic acid. Sodium, sodium allyl sulfonate, sodium methyl allyl sulfonate, sodium phenyl allyl ether sulfonate, sodium phenyl methallyl ether sulfonate, 2-acrylamido-methyl propane sulfonic acid (AMPs), vinylidene chloride, vinyl chloride, vinyl amine, and acrylate esters.

As used herein, the water soluble hydroxyl polymer is selected from the group consisting of polyvinyl alcohol, hydroxymethylcellulose, hydroxyethylcellulose, hydroxypropylmethylcellulose, and mixtures thereof. Non-limiting examples of suitable polyvinyl alcohols include those commercially available from Sekisui Specialty Chemicals America, LLC (Dallas, TX) under the trade name CELVOL®. Non-limiting examples of suitable hydroxypropyl methylcellulose include those commercially available from Dow Chemical Company (Midland, MI) under the trademark METHOCEL®, including combinations with the hydroxypropyl methylcellulose described above.

As used herein, the water-soluble thermoplastic polymers consists of examples of suitable water-soluble thermoplastic polymers include thermoplastic starch and/or starch derivatives, polylactic acid, polyhydroxyalkanoates, polycaprolactones, polyester amides, and certain polyesters or a combination thereof.

As used herein, the water-soluble thermoplastic polymer of the present invention may be hydrophilic or hydrophobic.

As used herein, the water soluble thermoplastic polymer may be surface treated and/or internally treated to alter the hydrophilic or hydrophobic properties inherent in the thermoplastic polymer.

As used herein, the water soluble thermoplastic polymer may comprise a biodegradable polymer. Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

As used herein, the non-polar solvent soluble materials include non-polar solvent soluble polymers. Non-limiting examples of suitable non-polar solvent soluble materials include cellulose, chitin, chitin derivatives, polyolefins, polyesters, copolymers thereof, and mixtures thereof. Non-limiting examples of polyolefins include polypropylene, polyethylene, and mixtures thereof. Non-limiting examples of polyesters include polyethylene terephthalate.

As used herein, nonpolar solvent soluble materials may include non-biodegradable polymers such as polypropylene, polyethylene, and certain polyesters. Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

As used herein, activators are a class of additives designed and intended to benefit something other than the filament itself, for example, benefiting the environment outside the filament. The active agent may be any suitable additive that produces the intended effect under the intended use of the filament. For example, the active agent may be a personal cleansing and conditioning agent such as a hair care agent such as a shampoo and/or hair dye agent, a hair conditioning agent, a skin care agent, a sunscreen agent, and a skin conditioning agent; laundry care and/or conditioning agents, such as fabric care agents, fabric conditioning agents, fabric softeners, fabric anti-wrinkle agents, fabric care antistatic agents, fabric care stain removers, soil release agents, dispersants, foam inhibitors, foaming agents, antifoaming agents, fabric refreshing agents; hard surface care and/or conditioning agents, e.g. liquid and/or powder dishwashing agents (for dishwashing or automatic dishwashing or hand dish washing), and abrasives; other cleaning and conditioning agents such as antibacterial agents, perfumes, bleaches (e.g. oxygen bleaching), hydrogen peroxide, percarbonate bleach, perborate bleach, chlorine bleach), bleach activator, chelating agent, builder, lotion, whitening agent, air care agent, carpet care agent, dye transfer inhibitor, water softener, pH adjuster, enzyme, flocculant, foaming agent, preservative, cosmetic agent, makeup remover, foaming agent, adhesion aid, coacervate forming material, clay, thickener, latex, silica, desiccant, odor inhibitor, antiperspirant, cooling agent, warming agent, absorbent gel, anti-inflammatory agent, dye, pigment, acid and base, liquid treatment active agent, agricultural active agent, industrial active agent, ingestion, drugs, tooth whitening agents, tooth care agents, mouthwashes, periodontal gum care agents, edible agents, edible agents, vitamins, minerals, and water treatment agents such as water purification and/or water disinfectants.

As used herein, the composition may contain one or more classes of chemicals that may be useful for one or more of the active agents listed above. For example, a surfactant active may be useful for any number of the active agents described above. Similarly, bleach can be used in fabric care, hard surface cleaning, dishwashing, and even tooth

whitening. Thus, those skilled in the art will appreciate that the active agent is selected based on the desired intended use of the filament and/or the nonwoven fabric made therefrom.

As used herein, the filaments of the present invention and/or nonwovens made therefrom should be used for hair care and/or conditioning thereof, whereby one or more surfactants, such as foamable surfactants, Filaments and/or non-woven fabrics incorporating filaments can be selected to provide the desired benefits to the consumer when exposed to the intended application conditions.

As used herein, the filaments of the invention and/or nonwovens made therefrom are designed or intended for use in laundry of clothes in a laundry operation, and then one or more suitable surfactants, or enzymes, or builders, or fragrances, or foam suppressors, or bleaching agents are desired when exposed to the intended use conditions of the filaments and/or nonwovens incorporating the filaments. Can be chosen to provide consumers with the benefits.

As used herein, the filaments of the invention and/or nonwovens made therefrom are designed to be used in washing fabrics in washing operations and/or washing dishes in dishwashing operations, wherein the filaments are then washed A detergent composition or dishwashing detergent composition may be included.

As used herein, the active agent comprises a perfume active agent. As used herein, the active agent comprises a non-surfactant.

As used herein, the active agent comprises an inactive active agent, i.e., an active agent other than an ingestible active agent.

As used herein, non-limiting examples of suitable surfactants include anionic surfactants, or cationic surfactants, or nonionic surfactants, or zwitterionic surfactants, or amphoteric surfactants, or a combination thereof. A co-surfactant may also be included in the filament. For example, for filaments designed for use as laundry detergents and/or dishwashing agents, the total surfactant concentration should be sufficient to provide cleaning including stain and/or odor removal. Generally in the range of about 0.5% to about 95%. In addition, surfactant systems comprising two or more surfactants designed for use in laundry detergent and/or dishwashing filaments are fully anionic surfactant systems, or a combination of two or more different anionic surfactants, or a mixture of different types of surfactant system, or a combination thereof.

As used herein, a surfactant or a combination of surfactants may be linear or branched surfactants.

As used herein suitable linear surfactants include those derived from agricultural chemical oils, such as coconut oil, palm kernel oil, soybean oil, or other vegetable oils.

As used herein, the suitable anionic surfactants may include alkyl sulfates, alkyl ether sulfates, branched alkyl sulfates, branched alkyl alkoxylates, branched alkoxylate sulfates, medium chain branched alkyl allyl sulfonate, sulfated monoglyceride, sulfonated olefin, alkyl allyl sulfonate, primary or secondary alkane sulfonate, alkyl sulfosuccinate, acyl taurate, acyl isethionate, alkyl glyceryl ether sulfonate, sulfonated methyl ester, sulfonated fatty acid, alkyl phosphate, acyl glutamate, acrylic sarcosinate, alkyl sulfoacetate, acylated peptide, alkyl ether carboxylate, anionic fluorosurfactants, sodium lauroyl glutamate, or a combinations thereof.

As used herein, the suitable alkyl sulfates and alkyl ether sulfates for use herein include materials having the corresponding formulas ROSO 3 M and RO (C 2 H 4 O) x SO 3 M, wherein R Is an alkyl or alkenyl from about 8 to about 24 carbon atoms, x is 1-10, and M is a water-soluble cation such as ammonium, sodium, potassium, and triethanolamine. Other suitable anionic surfactants are MacCutcheon's “Detergents and Emulsifiers” (North American Edition (1986), Allred Publishing Corp.) and Mccutcheon's “Functional Materials 92” (Natural Publishing Corp.).

As used herein, anionic surfactants useful in the filaments of the present invention, C 9-C 15 alkyl benzene sulfonates (LAS), C 8-C 20 alkyl ether sulfates, such as alkyl poly (ethoxy) sulfates, C 8˜C 20 alkyl sulfates, and mixtures thereof. Other anionic surfactants may include methyl ester sulfonate (MES), methyl ester etchelate (MEE), sulfonated estolides, and mixtures thereof.

As used herein, the anionic surfactant is a C 11-C 18 alkyl benzene sulfonate (“LAS”) and primary branched chain, andarandomC10-C20 alkylsulfate(“AS”), formulaCH3. (CH2)x(CHOSO3-M+)CH3andCH3(CH2)y(CHOS03-M +) C 10˜C 18 secondary of CH 2 CH 3 (2,3) alkyl sulfates (formula In which x and (y+1) are integers of at least about 7, preferably about 9, and M is a water-solubilizing cation, in particular sodium, an unsaturated sulfate such as oleyl sulfate), C 10-C 18 α-sulfonated fatty acid esters, C 10-C 18 sulfated alkyl polyglycosides, C 10-C 18 alkyl alkoxy sulfates (“AE X S”) (the formula x is 1 to 30), and C 10-C 18 alkyl alkoxy Ruboxylates (eg containing 1-5 ethoxy units), medium chain branched alkyl sulfates as described in U.S. Pat. Nos. 6,020,303 and 6,060,443; 6,008, medium chain branched alkyl alkoxy sulfates (MLAS) as described in 181 and 6,020,303; as described in WO 99/05243, WO 99/05242, and WO 99/05244 Modified alkylbenzene sulfonate (MILAS); methyl ester sulfonate (MES); and alpha-olefin sulfonate (AOS).

As used herein, other suitable anionic surfactants that can be used are alkyl ester sulfonate surfactants, including sulfonated linear esters of C 8 to C 20 carboxylic acids (ie fatty acids). The Other suitable anionic surfactants that can be used salts of soap, C 8-C 22 primary or secondary alkane sulfonates (primary of secondary alkanesulfonates), C 8 ˜C 24 olefin sulfonates, sulfonated polycarboxylic acids, C 8-C 24 alkyl polyglycol ether sulfates (alkylpolyglycolethersulfates) (contain ethylene oxide up to 10 moles); alkyl glycerol sulfonates, fatty acyl glycerol sulfonates, fatty oleoyl glycerol sulfates, alkyl phenol ethylene oxide ether sulfates, paraffin sulfonates, alkyl phosphates, isethionates, eg acyl isethionates, N-acyl taurates, alkyl succinates and sulfosuccinates, monoesters of sulfosuccinates (e.g. saturated and unsaturated C 12-C 18 monoesters) monoester, diester sulfosuccinates (e.g., saturated and unsaturated C 6-C 12 diesters), and alkyl polysaccharide sulfates, such as alkyl polysaccharides sulfates, and alkyl polyethoxy carboxylates such as those of the formula RO (CH 2 CH 2 O) k-CH 2 COO-M+(wherein R is a C 8-C 22 alkyl, k is an integer of 0, M is a soluble salt-forming cation).

As used herein, other suitable anionic surfactants are alkyl benzene sulphonic acid of C 10-C 16, preferably an alkali metal salt of alkylbenzene sulfonic acid C 11-C 14.

As used herein, the suitable anionic surfactants are linear alkyl group is linear such as alkyl benzene sulfonates are known as “LAS”. Such surfactants and their preparation are described, for example, in U.S. Pat. Nos. 2,220,099 and 2,477,383. In other examples, linear alkyl sulfonate or linear alkylbenzene sulfonate or liner alkyl benzene sulfonate.

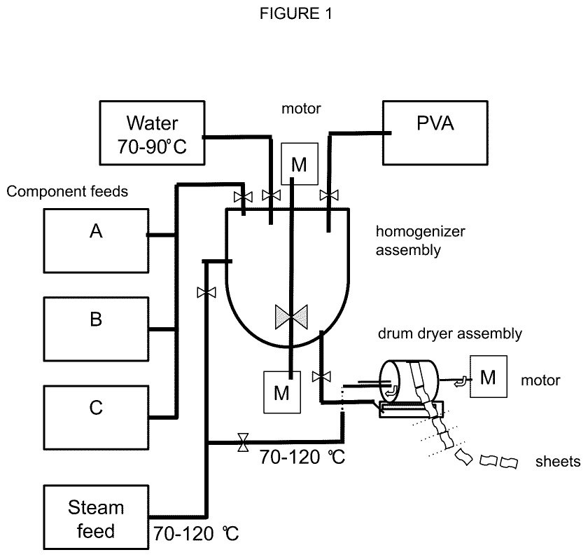

Referring now to the FIGURES, FIG. 1 is an illustration of a non-limiting embodiment of a homogenizer assembly, component feeds, and drum dryer assembly according to the invention. FIG. 1 shows water supply at 70-90° C. for delivery to the homogenizer tank via pumped delivery pipe with a control valve. The homogenizer tank includes a mixing paddle connected to electric motors. The PVA supply delivers polyvinyl alcohol to the homogenizer tank via pumped or gravity fed conduit for dissolving in the water. Component feeds A, B, C are delivered via pumped conduit to the homogenizer tank, and steam feed 70-120° C.

In the present invention the polyvinyl alcohol, water, a fragrance, and optionally additional ingredients, form a PVA homogenate by mixing in a single homogenizer tank, and the homogenizer tank is heated using steam.

The PVA paste/homogenate is pumped to the drum dryer assembly and delivered to a bottom feed tray having a bottom feed applicator roller disposed therein. The drum dryer comprises a heated drying drum having a drive system and a mirror finish, said drying drum mounted over a bottom applicator roller assembly having a bottom feed tray with a bottom feed applicator roller disposed therein, the bottom fed tray having a inlet for receiving the paste, the bottom feed applicator roller in operative contact with paste in the bottom feed tray, wherein rotational engagement between the drying drum and the bottom feed applicator roller forms a water dissolvable PVA fragrance sheet.

FIG. 1 also shows optional the optional step of trimming the water dissolvable PVA fragrance sheet to a form 1.5-2.0 mm thick, 50-127 mm wide, and 76-203 mm long.

In another non-limiting preferred embodiment, an additional step of surface spraying the water dissolvable PVA sheet with a surface agent selected from the group consisting of a additional of an odor removing agent selected from the group consisting of Ozium, Lysol, Damprid, Lemon, BioKeen, or a combination thereof, or odor neutralizing agent, such as hydrogen peroxide, or baking soda, or vinegar, or charcoal, or a combination thereof, laundry boosters selected from the group consisting of Lemon Juice, NaCl, Baking Soda, Alcohol, hydrogen peroxide, Vinegar, or a combination thereof, used to deodorize the odor of the laundry process, Citronellol, Rose oil, Limonene, Essential oils, Sodium Bicarbonate or a combination thereof, Clay, Bentonite Clay, Minerals, Pine, Wheat, Corn, Silica, Silica Gel, or a combination thereof, Essential oils, Sodium Bicarbonate, or a combination thereof, Disodium ethylenediaminetetraacetate dihydrate, Na2EDTA, DTPA, MGDA, EDTA or a combination thereof, Borax, Sodium Bicarbonate, Charcoal, Hypochlorite, hydrogen peroxide, vinegar, or a combination thereof, Epsom Salt, Sodium Bicarbonate, Bentonite Clay, hydrogen peroxide, vinegar, or a combination thereof, Essential oils, Lavender, Peppermint, Lemon, Bergamot, Ylang Ylang, Hydrosols, Resins, Carrier oils, Infused oils, Herbs, or a combination thereof, Perfume MicroCapsules or a combination of Perfume Micro Capsules, used for the delivery of a two-step odor release composition wherein one step is right out of the washer and/or dryer during the washing process and will also release scent after said washing and drying garment process, a chelating agent selected from the group consisting of EDTA, MGDA, DTPA, zeolite, phosphonate, citric acid, citrate, or a mixture thereof, a fragrance 0 to 2% by weight, a brightening agent up to 1% by weight of the total mixture, a bleaching agent selected from the group consisting of calcium hypochlorite, sodium hypochlorite, sodium percarbonate, sodium perborate, sodium persulfate, tetrasodium pyrophosphate, or urea peroxide or a combination thereof, a fabric softener agent selected from the group consisting o fquaternary ammonium cations/salts, ceterinium bromide, quaternary ammonium chloride, polydimethylsiloxane, silicone, or a mixture thereof, a perfume, a fragrance, a perfume micro capsule or a combination thereof, a binding agent selected from the group consisting of a resin, a wax, a gum, accroides, candelilla, guar, gum Arabic, shellac, tragacanth, or a combination thereof, and scent absorbing ingredients selected from the group consisting of activated charcoal, beta cyclodextrins, odor absorbing fabrics which contains porous chambers, porous clays, waxes that can hold scents, lava rocks, felt pads, cardboard, and potpourri.

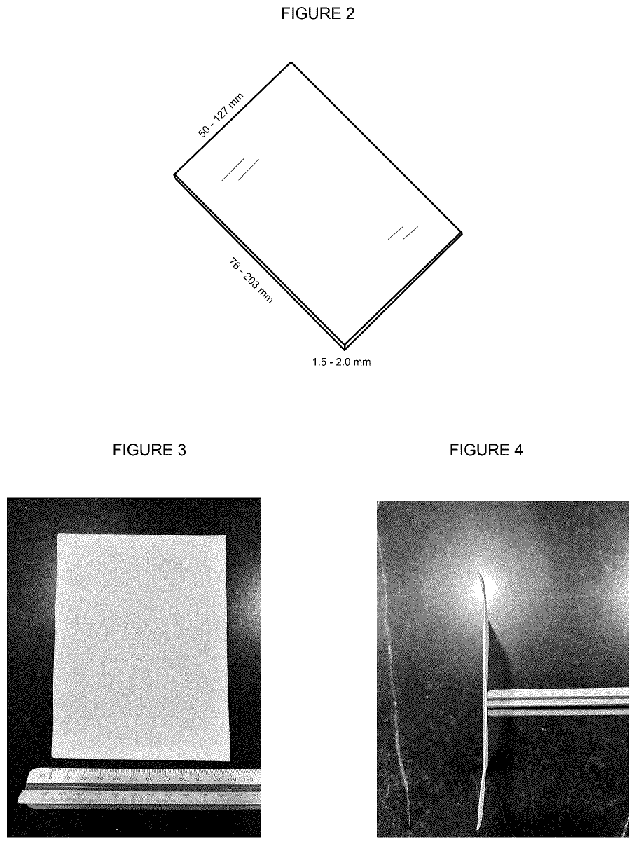

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

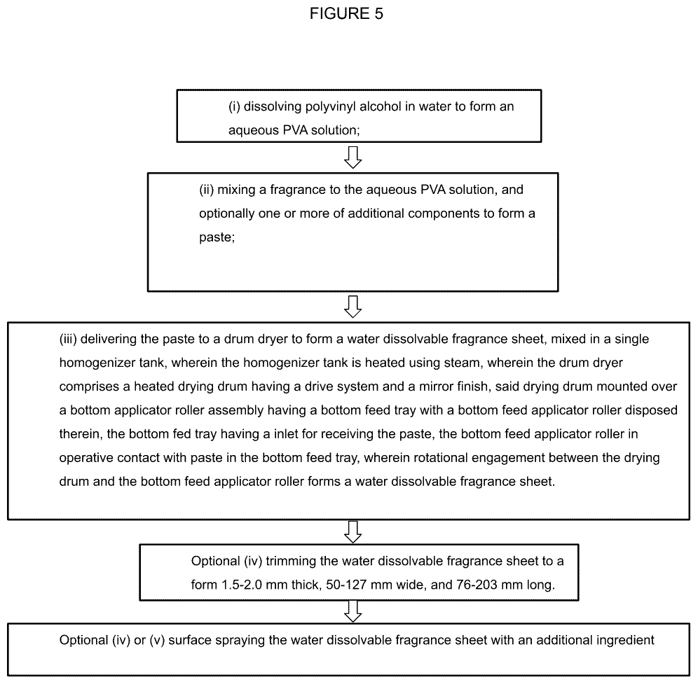

FIG. 5 is a flow chart illustration of a non-limiting embodiment of a method of manufacturing a water dissolvable PVA sheet using a homogenizer assembly, a supply for component feeds, and a drum dryer assembly according to the invention.

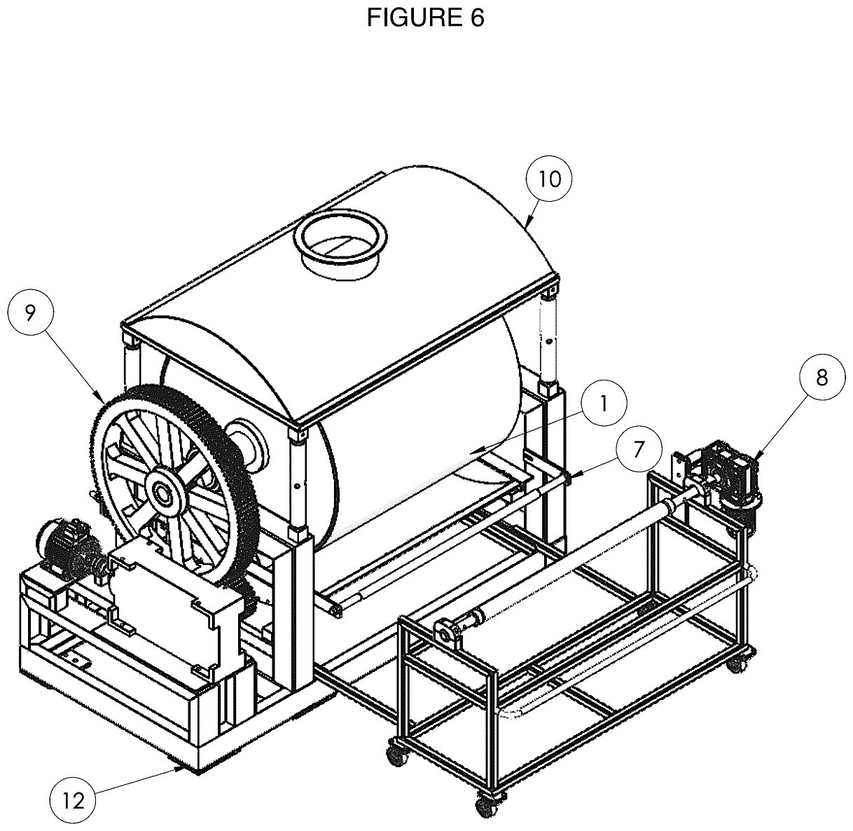

FIG. 6 is a perspective illustration of a non-limiting embodiment of a drum dryer assembly showing a drum drive and a sheet winding assembly. FIG. 6 shows drying drum gear system 9 with a motor having a variable frequency drive (VFD) gearbox pinion gear and main drum gear. FIG. 6 shows vapor outlet in canopy 10 with up/down movement scaffolding. Drying drum 1 is shown over the applicator try and adjacent to the final product sheet guide roller 7. Final product sheet winding roller assembly 8 with drive system and VFD is shown in position to receive the dried sheet.

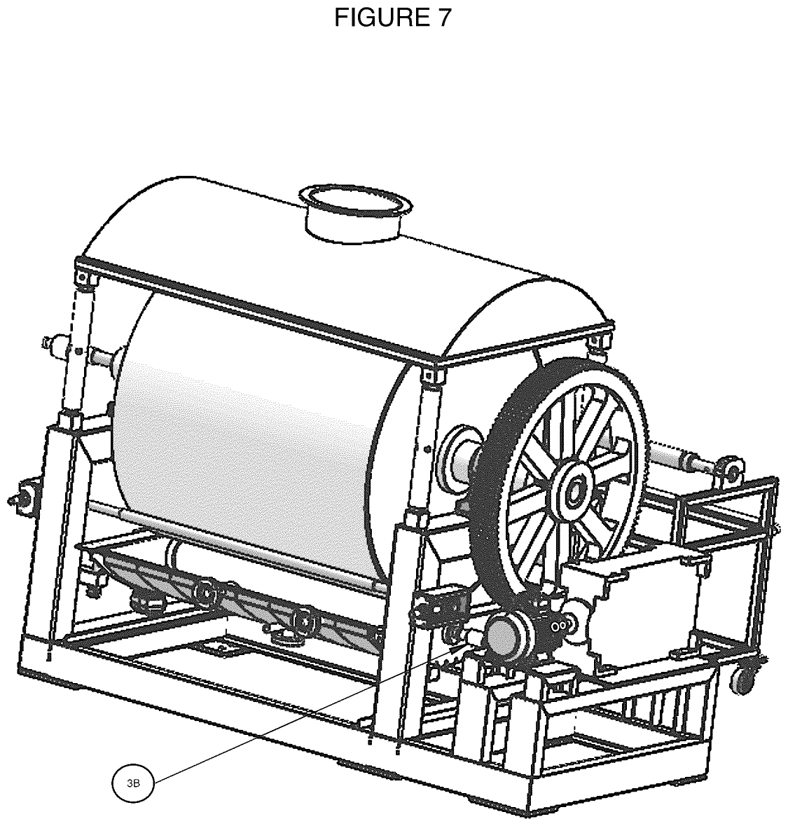

FIG. 7 is a perspective illustration of a non-limiting embodiment of a drum dryer assembly showing a drum drive. FIG. 7 shows drum/feed applicator roller 3B with a rotary joint for a steam inlet and condensate outlet for the drum.

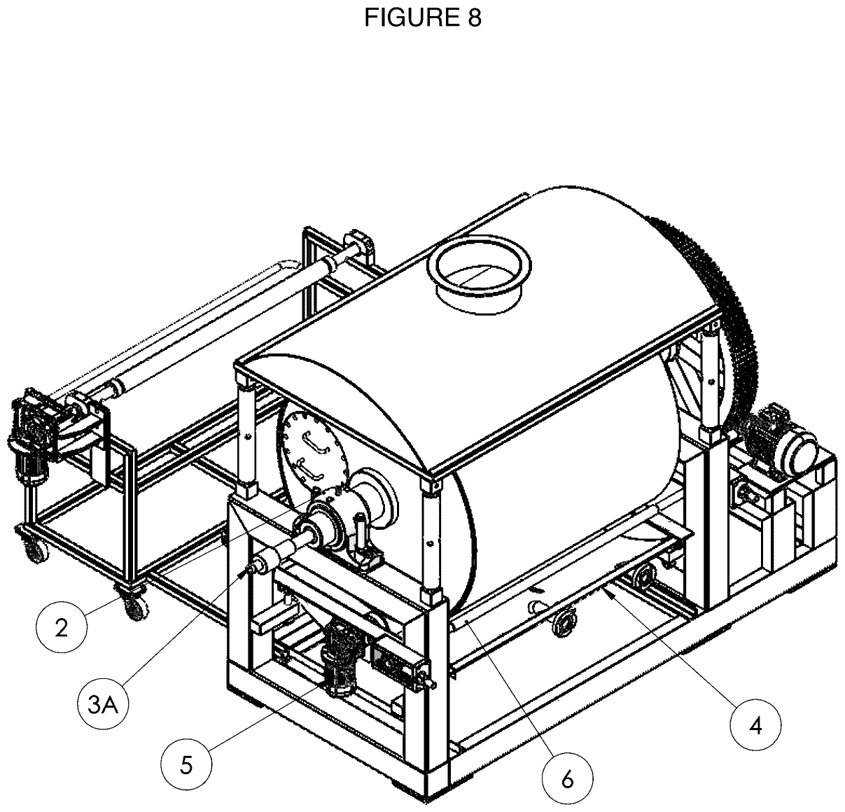

FIG. 8 is a perspective illustration of a non-limiting embodiment of a drum dryer assembly showing a drum drive and steam inlet. FIG. 8 shows drum bearing support 2. FIG. 8 also shows 3A rotary joint for a steam inlet for the drum. A bottom feed applicator roller 5 is shown having a drive system and VFD. A feed leveling roller 6 with a UCT bearing arrangement for level distance setting using feeler gauges is also shown. Bottom feed tray 4 is shown and contains nozzles with an electric ceramic heater.

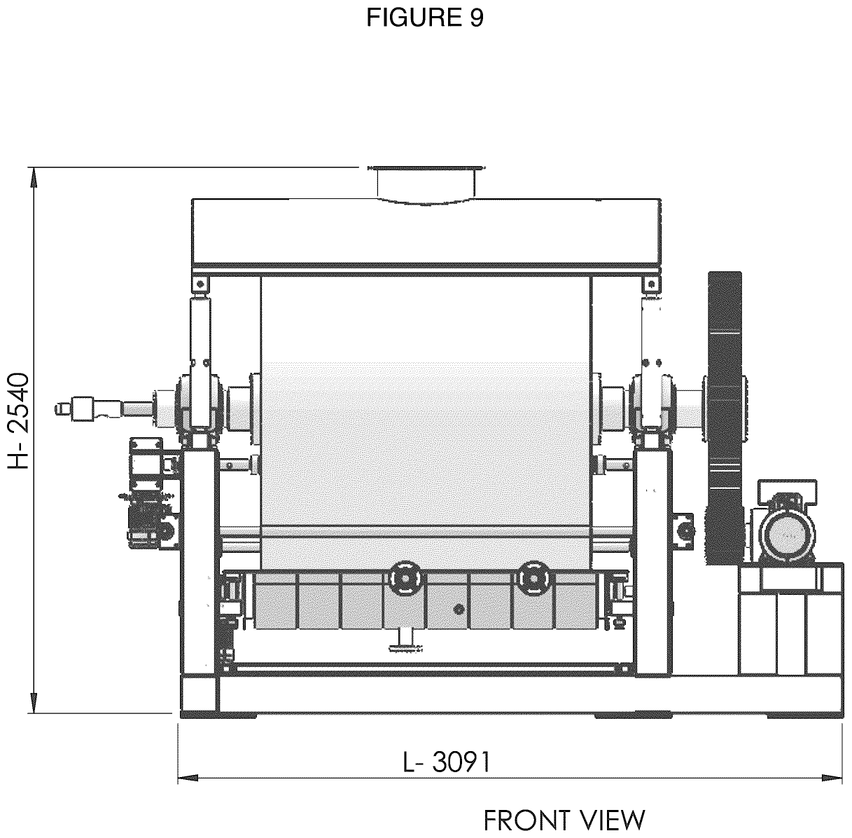

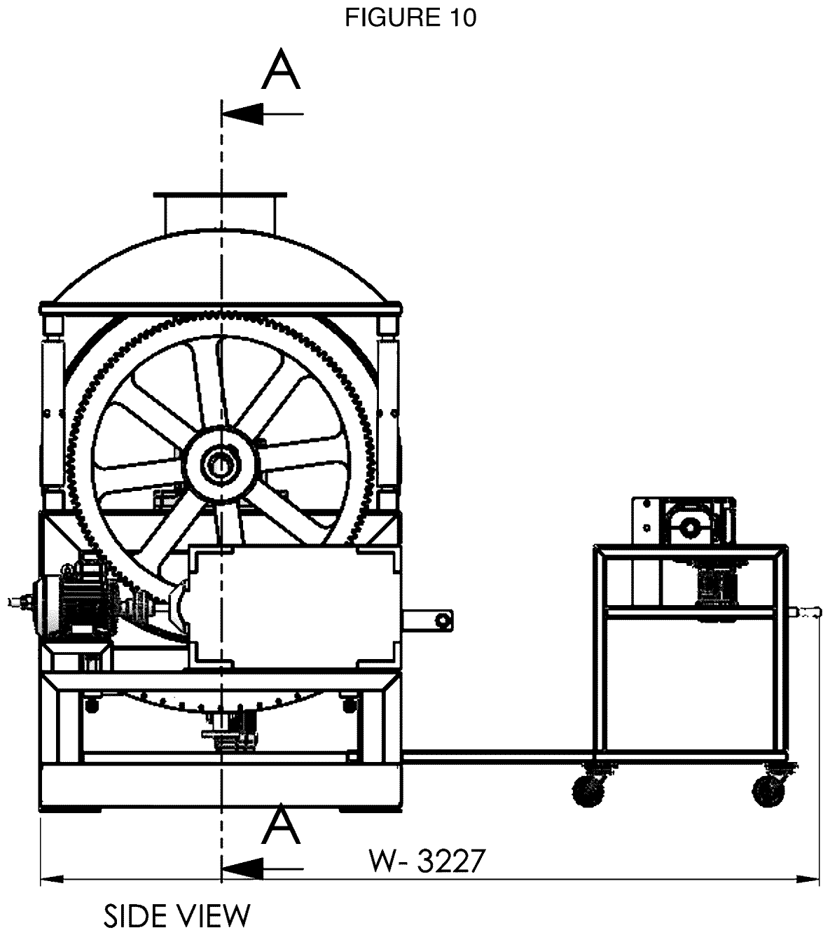

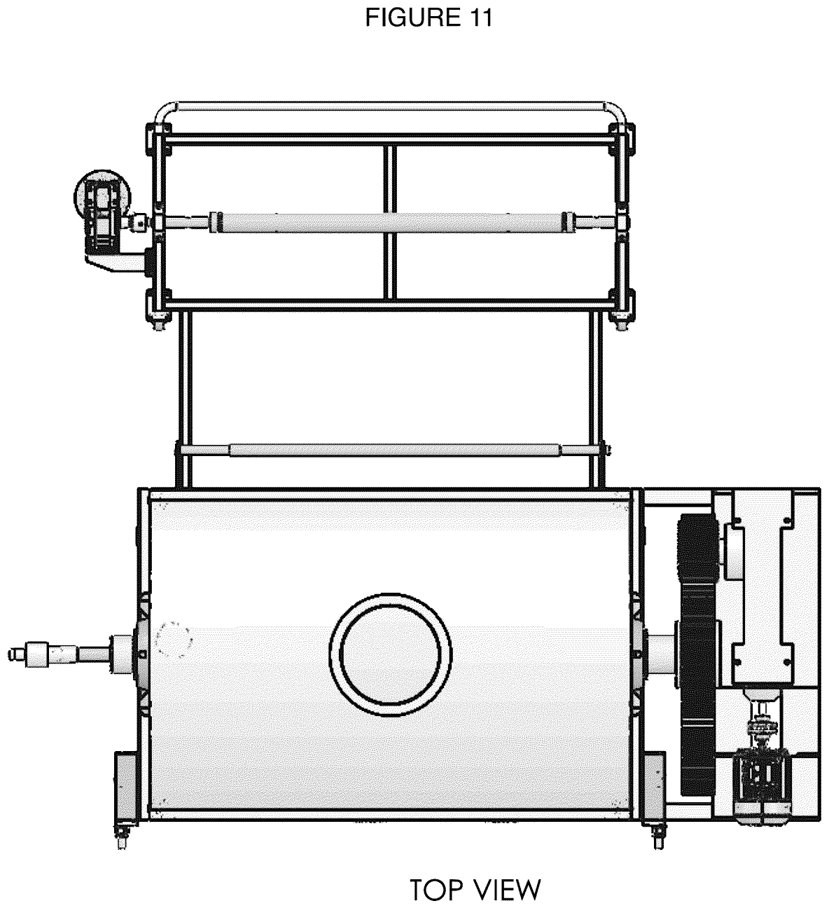

FIG. 9 is an side view illustration of a non-limiting embodiment of a drum dryer assembly showing a drum drive, a steam inlet, and applicator roller tray.

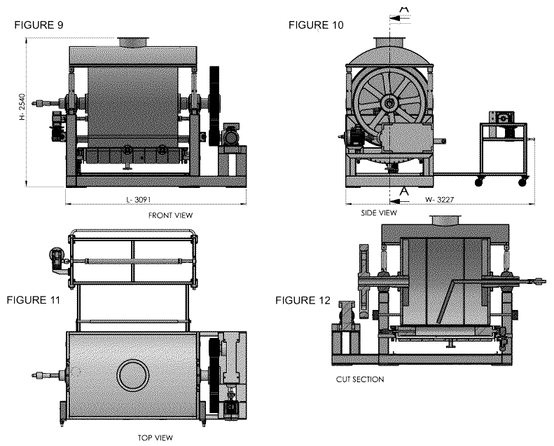

FIG. 10 is an end view illustration of a non-limiting embodiment of a drum dryer assembly showing a drum drive, motor, and sheet winding assembly.

FIG. 11 is a top view illustration of a non-limiting embodiment of a drum dryer assembly showing a drum drive, motor, and sheet winding assembly.

FIG. 12 is a cut-away view illustration of a non-limiting embodiment of a drum dryer assembly showing a drum drive, motor, dryer drum, roller tray, roller, and steam delivery conduit.

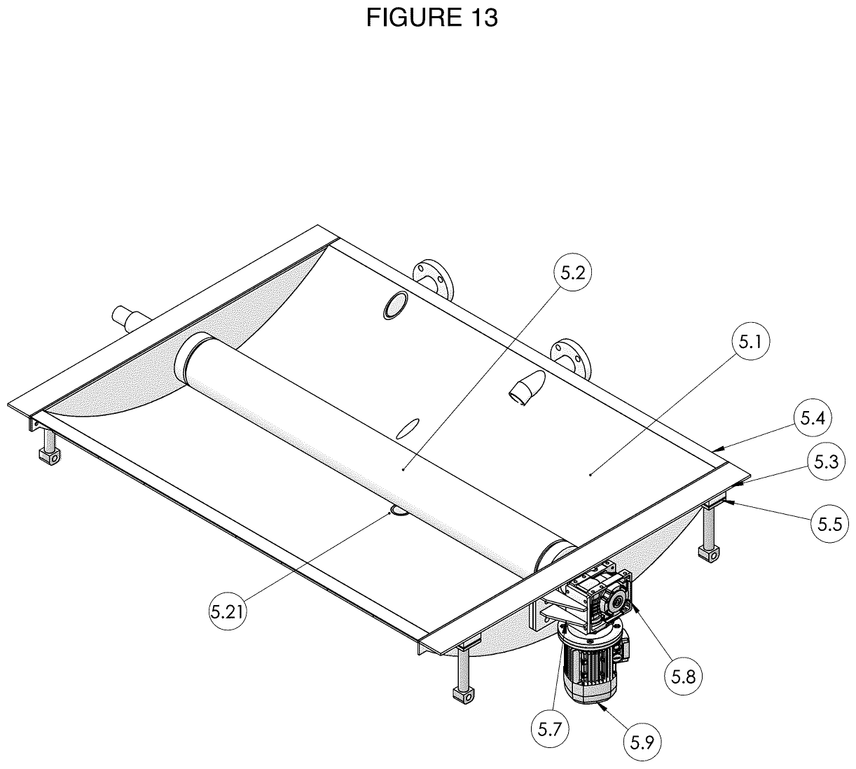

FIG. 13 is an perspective illustration of a non-limiting embodiment of an applicator roller tray, and roller assembly. FIG. 13 shows applicator roller pipe with PFTE coating 5.2 as part of the applicator tray. Drain 5.21 is shown at the bottom of the tray and roller motor is shown with 5.7 gearbox mounting bracket, 5.8 gearbox, and motor 5.9. Assembly lifting mechanism 5.5 is shown mounted on the tray lower surface.

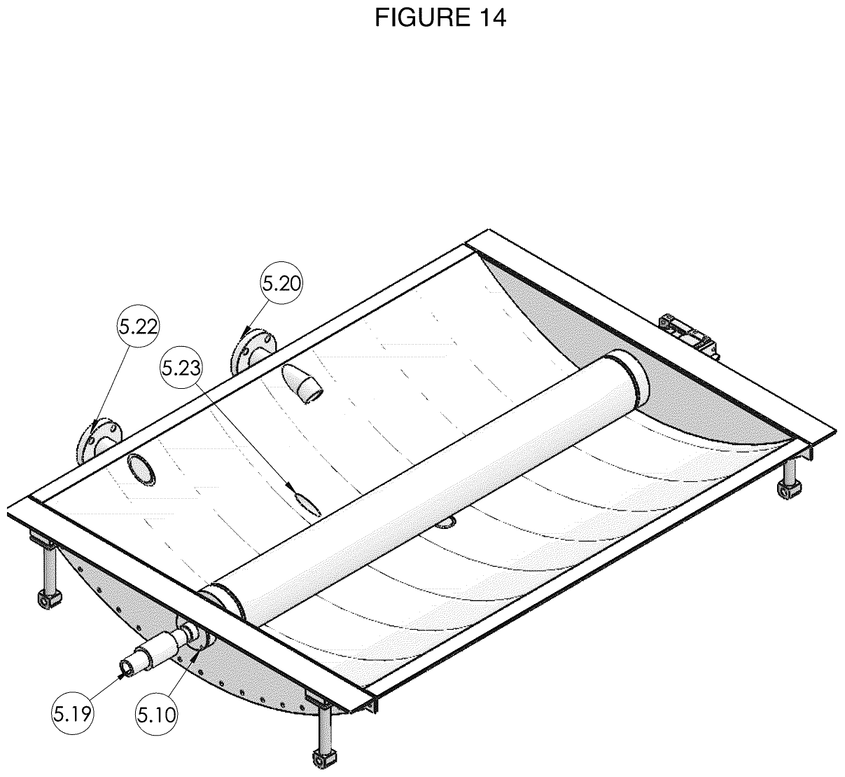

FIG. 14 is an perspective illustration of a non-limiting embodiment of an applicator roller tray, and roller assembly. FIG. 14 shows overflow nozzle 5.22, drain 5.23, and feed inlet 5.20 for paste. Applicator tray also shows a heater unit 5.10.

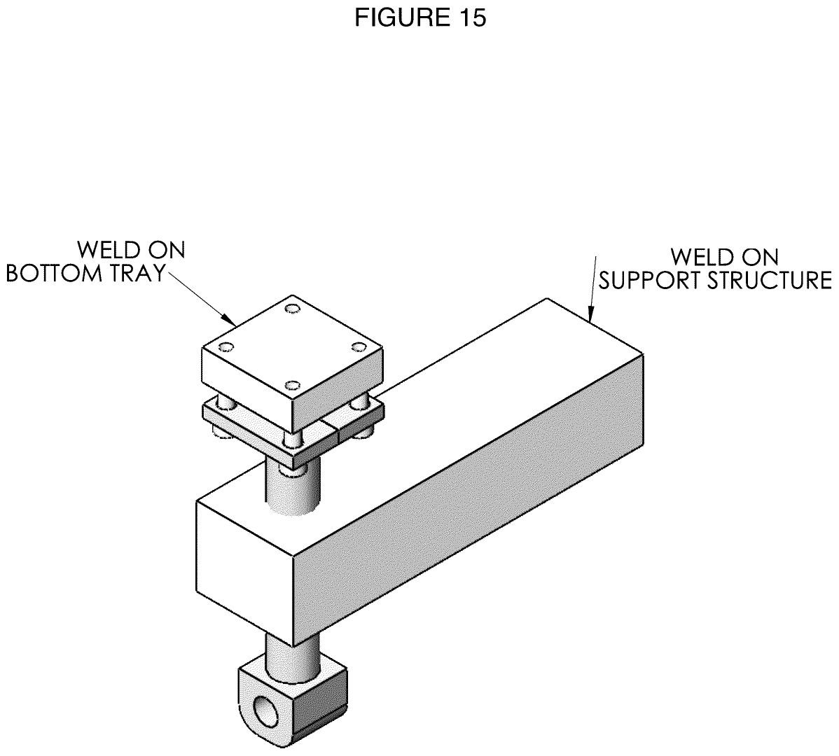

FIG. 15 is an perspective illustration of a non-limiting embodiment of a tray raising/lowering assembly.

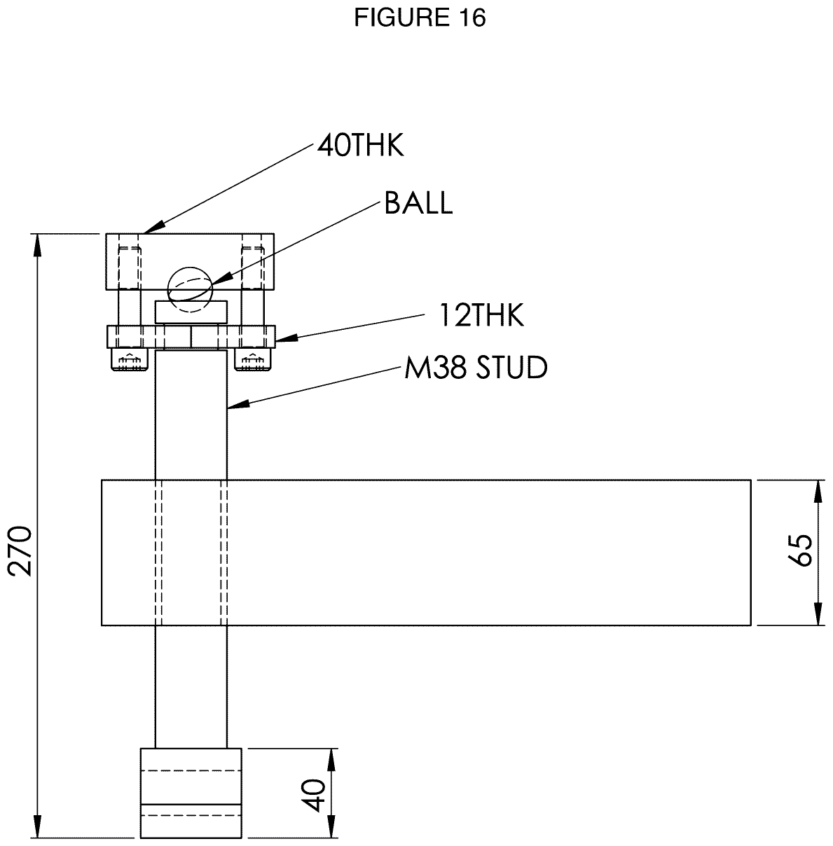

FIG. 16 is a side view illustration of a non-limiting embodiment of a tray raising/lowering assembly.

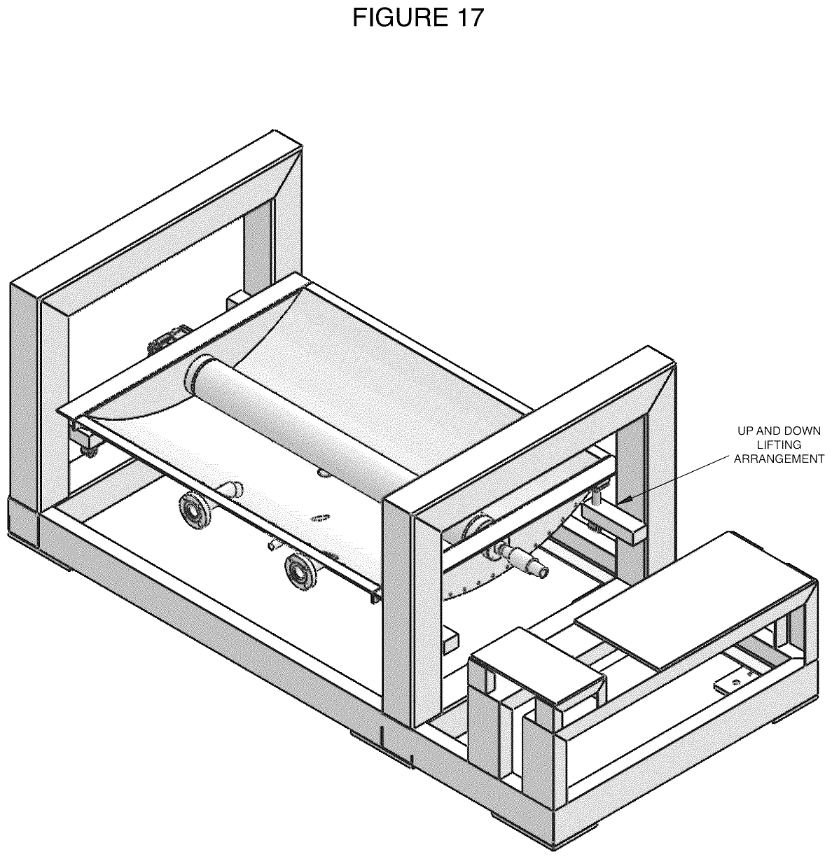

FIG. 17 is an perspective illustration of a non-limiting embodiment of an applicator tray, roller, and tray raising/lowering assembly.

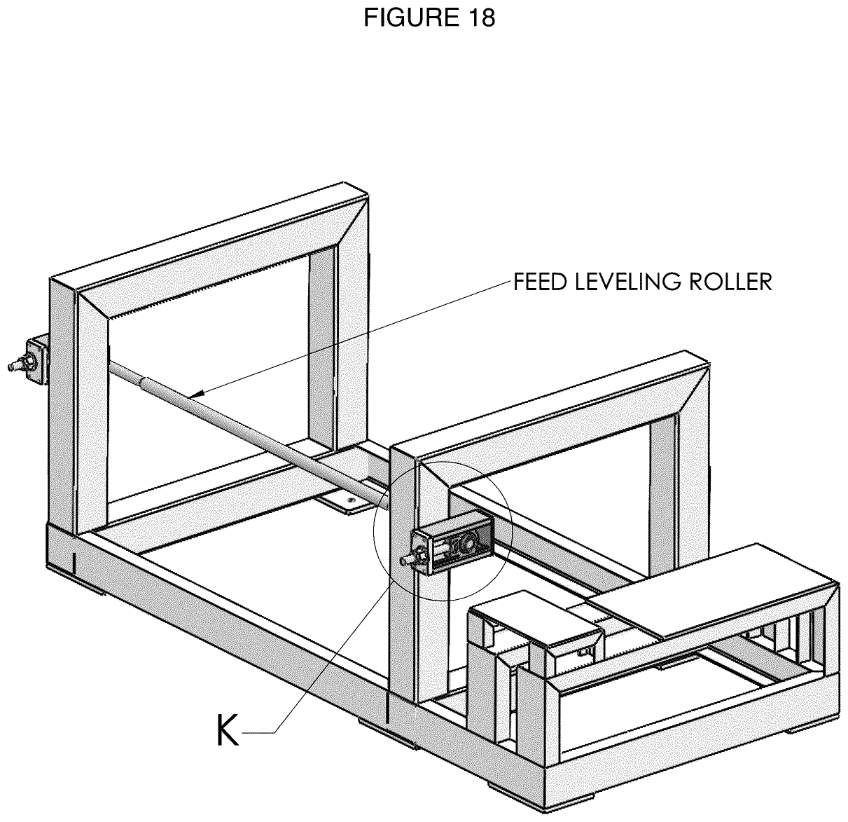

FIG. 18 is an perspective illustration of a non-limiting embodiment of a (sheet) feed leveling roller assembly.

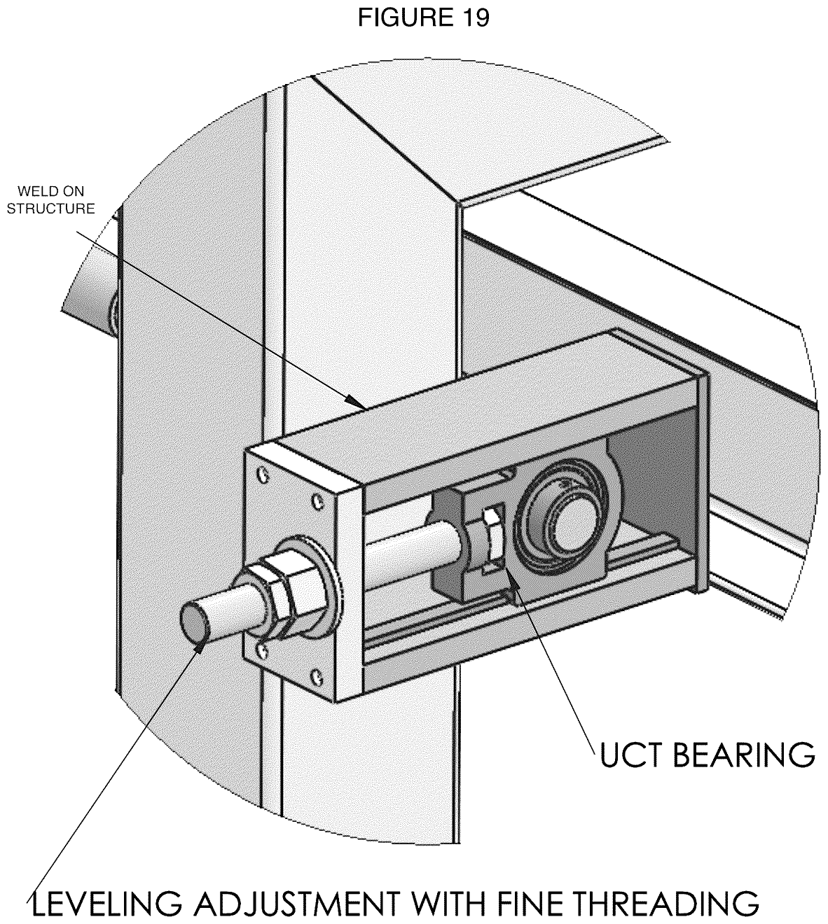

FIG. 19 is a detailed illustration of a non-limiting embodiment of a leveling adjustment mechanism for the (sheet) feed leveling roller assembly.

### Terminology

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

### EQUIVALENTS

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1. A process for manufacturing a water dissolvable fragrance sheet, comprising the steps:
(i) homogenizing in a high shear mixer at a temperature of 70-90° C. an aqueous solution of polyvinyl alcohol, a surfactant 5-50%, a builder 0.1-5%, a binding agent 0.1-5%, a chelating agent 0.1-5%, and a fragrance ingredient selected from the group consisting of perfume, citronellol, rose oil, limonene, an essential oil, pine oil, lavender, peppermint, lemon, bergamot, ylang ylang, a hydrosol, a resin, a carrier oil, an infused oil, an herb, or a combination thereof;
(ii) casting the PVA homogenate as a wet film onto a heated stainless steel roller drum having a drive system and a mirror finish and dehydrating at 70-120° C. using steam heat to obtain a water dissolvable fragrance sheet 1.5-2.0 mm thick, wherein said heated stainless steel roller drum is mounted over a bottom applicator roller assembly having a bottom feed tray with a bottom feed applicator roller disposed therein, the bottom feed tray having a inlet for receiving the PVA homogenate, the bottom feed applicator roller in operative contact with PVA homogenate in the bottom feed tray, wherein rotational engagement between the heated stainless steel roller drum and the bottom feed applicator roller forms the water dissolvable fragrance sheet ; and
(iii) optionally trimming the water dissolvable fragrance sheet to form a single sheet size 50-127 mm wide and 76-203 mm length, all percentages by weight, all percentages total 100%.

2. The process according to claim 1, wherein said water dissolvable fragrance sheet is used with the additional of an odor removing agent selected from the group consisting of Ozium, Lysol, Damprid, Lemon, BioKeen, or a combination thereof, or odor neutralizing agent, such as hydrogen peroxide, or baking soda, or vinegar, or charcoal, or a combination thereof

3. The process according to claim 1, further comprising the step of adding to the aqueous solution a perfume micro capsule.

4. The process according to claim 1, further comprising the step of adding to the aqueous solution a laundry booster selected from the group consisting of Lemon Juice, NaCl, Baking Soda, Alcohol, hydrogen peroxide, Vinegar, or a combination thereof, used to deodorize the odor of the laundry process.

5. (canceled)

6. The process according to claim 1, further comprising the step of adding to the aqueous solution an ingredient selected from the group consisting of Clay, Bentonite Clay, Minerals, Pine, Wheat, Corn, Silica, Silica Gel, or a combination thereof.

7. The process according to claim 1, further comprising the step of adding to the aqueous solution an ingredient selected from the group consisting of Essential oils, Sodium Bicarbonate, or a combination thereof.

8. The process according to claim 1, further comprising the step of adding to the aqueous solution an ingredient selected from the group consisting of Disodium ethylenediaminetetraacetate dihydrate, Na2EDTA, DTPA, MGDA, EDTA or a combination thereof.

9. The process according to claim 1, further comprising the step of adding to the aqueous solution an ingredient selected from the group consisting of Borax, Sodium Bicarbonate, Charcoal, Hypochlorite, hydrogen peroxide, vinegar, or a combination thereof.

10. The process according to claim 1, further comprising the step of adding to the aqueous solution an ingredient selected from the group consisting of EpsonSalt, Sodium Bicarbonate, Bentonite Clay, hydrogen peroxide, vinegar, or a combination thereof.

11. (canceled)

12. The process according to claim 1, further comprising the step of adding to the aqueous solution Perfume Micro Capsules formulated for delivery of a two-step fragrance release composition wherein one fragrance release step is in a washing machine cycle during the washing process and a second fragrance release step is during a drying garment process.

13. The process according to claim 1, further comprising the step of adding to the aqueous solution a surfactant selected from the group consisting of sodium lauryl sulfate, sodium dioctyl sulfosuccinate, linear alkyl benzene sulfonate, alpha olefin sulfonate, xylene sulfonate, sodium dodecylbenzene sulfonate, sodium laureth sulfate, and a combination thereof.

14. The process according to claim 13 wherein the surfactant constitutes between 5 to 50% by weight of the total mixture, and wherein the water constitutes between 1-15% by weight of the total mixture.

15. The process according to claim 1, wherein the chelating agent selected from the group consisting of EDTA, MGDA, DTPA, zeolite, phosphonate, citric acid, citrate, or a mixture thereof.

16. The process according to claim 1, wherein the fragrance 0 to 2% by weight.

17. The process according to claim 1, further comprising the step of adding to the aqueous solution a bleaching agent up to 1% by weight of the total mixture.

18. The process according to claim 17 comprising a bleaching agent selected from the group consisting of calcium hypochlorite, sodium hypochlorite, sodium percarbonate, sodium perborate, sodium persulfate, tetrasodium pyrophosphate, or urea peroxide or a combination thereof.

19. The process according to claim 1, further comprising the step of adding to the aqueous solution a fabric softener agent selected from the group consisting of quaternary ammonium cations/salts, ceterinium bromide, quaternary ammonium chloride, polydimethylsiloxane, silicone, or a mixture thereof.

20. (canceled)

21. The process according to claim 1, wherein the binding agent selected from the group consisting of a resin, a wax, a gum, accroides, candelilla, guar, gum Arabic, shellac, tragacanth, or a combination thereof.

22. A water dissolvable fragrance sheet made according to the process of claim 1.

23. The process according to claim 1, further comprising the step of adding to the aqueous solution a matrix scent absorbing ingredients selected form the group consisting of activated charcoal, beta cyclodextrins, odor absorbing fabrics which contains porous chambers, porous clays, waxes that can hold scents, lava rocks, felt pads, cardboard, and potpourri.
